(19) United States
(12) Patent Application Publication
(10) Pub. No.: US 2025/0103178 A1
(43) Pub. Date: Mar. 27, 2025

(54) NAVIGATION OF USER INTERFACES

(71) Applicant: Apple Inc., Cupertino, CA (US)

(72) Inventors: Conrad H. ALBRECHT-BUEHLER, Sunnyvale, CA (US); Richard R. DELLINGER, San Jose, CA (US); Nicholas J. HOPE, Redwood City, CA (US); Yun Jae KIM, Sunnyvale, CA (US); Kyle C. KRAFT, Half Moon Bay, CA (US); Nitigarn SIRIPANICH, Campbell, CA (US)

(21) Appl. No.: 18/887,942

(22) Filed: Sep. 17, 2024

Related U.S. Application Data
(60) Provisional application No. 63/657,912, filed on Jun. 9, 2024.
(60) Provisional application No. 63/540,320, filed on Sep. 25, 2023.

(51) Int. Cl. G06F 3/04817; G06F 3/04842

(52) U.S. Cl. CPC G06F 3/04817; G06F 3/04842

(57) ABSTRACT

The present disclosure generally relates to techniques for navigating one or more user interfaces, such as to access a folder or an application.

### CROSS-REFERENCE TO RELATED APPLICATIONS

This application claims priority to U.S. Provisional Application No. 63/540,320, entitled “NAVIGATION OF USER INTERFACES,” filed on Sep. 25, 2023, and U.S. Provisional Application No. 63/657,912, entitled “NAVIGATION OF USER INTERFACES,” filed on Jun. 9, 2024, both of which are hereby incorporated by reference in their entirety.

### FIELD

The present disclosure relates generally to computer user interfaces, and more specifically to techniques for navigating one or more user interfaces.

### BACKGROUND

Computer user interface techniques enable a user to interact with a computer system. The user optionally provides user inputs and the computer system optionally provides outputs, often in the form of feedback that is based on the user inputs.

### BRIEF SUMMARY

Some techniques for navigating user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for navigating user interfaces. Such methods and interfaces optionally complement or replace other methods for navigating user interfaces. Such methods and interfaces reduce the cognitive burden on a user and produce a more efficient human-machine interface. For battery-operated computing devices, such methods and interfaces conserve power and increase the time between battery charges.

In some embodiments, a method is described. The method comprises: at a computer system, wherein the computer system is in communication with one or more display generation components: displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including: a first icon of a first lightweight application that corresponds to a first operation of the first full application, wherein activation of the first icon causes display, via the one or more display generation components, of a user interface of the first lightweight application corresponding to the first operation of the first full application; and a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application; after displaying the first user interface that includes the folder, receiving a request to download and/or install an application; and in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

In some embodiments, a non-transitory computer-readable storage medium is described. The non-transitory computer-readable storage medium stores one or more programs configured to be executed by one or more processors of a computer system that is in communication with one or more display generation components, the one or more programs including instructions for: displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including: a first icon of a first lightweight application that corresponds to a first operation of the first full application, wherein activation of the first icon causes display, via the one or more display generation components, of a user interface of the first lightweight application corresponding to the first operation of the first full application; and a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application; after displaying the first user interface that includes the folder, receiving a request to download and/or install an application; and in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

In some embodiments, a transitory computer-readable storage medium is described. The transitory computer-readable storage medium stores one or more programs configured to be executed by one or more processors of a computer system that is in communication with one or more display generation components, the one or more programs including instructions for: displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including: a first icon of a first lightweight application that corresponds to a first operation of the first full application, wherein activation of the first icon causes display, via the one or more display generation components, of a user interface of the first lightweight application corresponding to the first operation of the first full application; and a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application; after displaying the first user interface that includes the folder, receiving a request to download and/or install an application; and in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

In some embodiments, a computer system is described. The computer system is configured to communicate with one or more display generation components, and comprises: one or more processors; and memory storing one or more programs configured to be executed by the one or more processors, the one or more programs including instructions for: displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including: a first icon of a first lightweight application that corresponds to a first operation of the first full application, wherein activation of the first icon causes display, via the one or more display generation components, of a user interface of the first lightweight application corresponding to the first operation of the first full application; and a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application; after displaying the first user interface that includes the folder, receiving a request to download and/or install an application; and in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

In some embodiments, a computer system is described. The computer system is configured to communicate with one or more display generation components, and comprises: means for displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including: a first icon of a first lightweight application that corresponds to a first operation of the first full application, wherein activation of the first icon causes display, via the one or more display generation components, of a user interface of the first lightweight application corresponding to the first operation of the first full application; and a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application; means, after displaying the first user interface that includes the folder, for receiving a request to download and/or install an application; and means, responsive to receiving the request to download and/or install the application and in accordance with a determination that the application is the first full application, for automatically updating the first user interface to replace the folder with an icon of the first full application, wherein activation of the icon of the first full application causes display, via the one or more display generation components, of a user interface of the first full application.

In some embodiments, a computer program product is described. The computer program product comprises one or more programs configured to be executed by one or more processors of a computer system that is in communication with one or more display generation components, the one or more programs including instructions for: displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including: a first icon of a first lightweight application that corresponds to a first operation of the first full application, wherein activation of the first icon causes display, via the one or more display generation components, of a user interface of the first lightweight application corresponding to the first operation of the first full application; and a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application; after displaying the first user interface that includes the folder, receiving a request to download and/or install an application; and in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

In some embodiments, a method is described. The method comprises: at a computer system that is in communication with one or more display generation components and one or more input devices: displaying, via the one or more display generation components, a first user interface that includes a plurality of icons, wherein the plurality of icons includes: a first icon of a first application, wherein activation of the first icon causes display, via the one or more display generation components, of a user interface of the first application; and a second icon of a second application that is different from the first application, wherein activation of the second icon causes display, via the one or more display generation components, of a user interface of the second application; while displaying the first user interface that includes the plurality of icons, detecting, via the one or more input devices, a first input; in response to detecting the first input and in accordance with a determination that the first input corresponds to a first request, displaying, via the one or more display generation components, a second user interface that includes a plurality of application category options, wherein the plurality of application category options includes: a first category option that corresponds to a first set of applications with a first shared characteristic that includes having an unread notification; and a second category option that corresponds to a second set of applications with a second shared characteristic that is different from the first shared characteristic, wherein the second set of applications is different from the first set of applications; while displaying the second user interface that includes the plurality of application category options, detecting, via the one or more input devices, a second input; and in response to detecting the second input: in accordance with a determination that the second input activates the first category option, displaying, via the one or more display generation components, application icons of the first set of applications with the first shared characteristic that includes having an unread notification; and in accordance with a determination that the second input activates the second category option, displaying, via the one or more display generation components, application icons of the second set of applications with the second shared characteristic.

In some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a first user interface that includes a plurality of icons, wherein the plurality of icons includes: a first icon of a first application, wherein activation of the first icon causes display, via the one or more display generation components, of a user interface of the first application; and a second icon of a second application that is different from the first application, wherein activation of the second icon causes display, via the one or more display generation components, of a user interface of the second application; while displaying the first user interface that includes the plurality of icons, detecting, via the one or more input devices, a first input; in response to detecting the first input and in accordance with a determination that the first input corresponds to a first request, displaying, via the one or more display generation components, a second user interface that includes a plurality of application category options, wherein the plurality of application category options includes: a first category option that corresponds to a first set of applications with a first shared characteristic that includes having an unread notification; and a second category option that corresponds to a second set of applications with a second shared characteristic that is different from the first shared characteristic, wherein the second set of applications is different from the first set of applications; while displaying the second user interface that includes the plurality of application category options, detecting, via the one or more input devices, a second input; and in response to detecting the second input: in accordance with a determination that the second input activates the first category option, displaying, via the one or more display generation components, application icons of the first set of applications with the first shared characteristic that includes having an unread notification; and in accordance with a determination that the second input activates the second category option, displaying, via the one or more display generation components, application icons of the second set of applications with the second shared characteristic.

In some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a first user interface that includes a plurality of icons, wherein the plurality of icons includes: a first icon of a first application, wherein activation of the first icon causes display, via the one or more display generation components, of a user interface of the first application; and a second icon of a second application that is different from the first application, wherein activation of the second icon causes display, via the one or more display generation components, of a user interface of the second application; while displaying the first user interface that includes the plurality of icons, detecting, via the one or more input devices, a first input; in response to detecting the first input and in accordance with a determination that the first input corresponds to a first request, displaying, via the one or more display generation components, a second user interface that includes a plurality of application category options, wherein the plurality of application category options includes: a first category option that corresponds to a first set of applications with a first shared characteristic that includes having an unread notification; and a second category option that corresponds to a second set of applications with a second shared characteristic that is different from the first shared characteristic, wherein the second set of applications is different from the first set of applications; while displaying the second user interface that includes the plurality of application category options, detecting, via the one or more input devices, a second input; and in response to detecting the second input: in accordance with a determination that the second input activates the first category option, displaying, via the one or more display generation components, application icons of the first set of applications with the first shared characteristic that includes having an unread notification; and in accordance with a determination that the second input activates the second category option, displaying, via the one or more display generation components, application icons of the second set of applications with the second shared characteristic.

In some embodiments, a computer system is described. The computer system is configured to communicate with one or more display generation components and one or more input devices and comprises: one or more processors; and memory storing one or more programs configured to be executed by the one or more processors, the one or more programs including instructions for: displaying, via the one or more display generation components, a first user interface that includes a plurality of icons, wherein the plurality of icons includes: a first icon of a first application, wherein activation of the first icon causes display, via the one or more display generation components, of a user interface of the first application; and a second icon of a second application that is different from the first application, wherein activation of the second icon causes display, via the one or more display generation components, of a user interface of the second application; while displaying the first user interface that includes the plurality of icons, detecting, via the one or more input devices, a first input; in response to detecting the first input and in accordance with a determination that the first input corresponds to a first request, displaying, via the one or more display generation components, a second user interface that includes a plurality of application category options, wherein the plurality of application category options includes: a first category option that corresponds to a first set of applications with a first shared characteristic that includes having an unread notification; and a second category option that corresponds to a second set of applications with a second shared characteristic that is different from the first shared characteristic, wherein the second set of applications is different from the first set of applications; while displaying the second user interface that includes the plurality of application category options, detecting, via the one or more input devices, a second input; and in response to detecting the second input: in accordance with a determination that the second input activates the first category option, displaying, via the one or more display generation components, application icons of the first set of applications with the first shared characteristic that includes having an unread notification; and in accordance with a determination that the second input activates the second category option, displaying, via the one or more display generation components, application icons of the second set of applications with the second shared characteristic.

In some embodiments, a computer system is described. The computer system is configured to communicate with one or more display generation components and one or more input devices and comprises: means for displaying, via the one or more display generation components, a first user interface that includes a plurality of icons, wherein the plurality of icons includes: a first icon of a first application, wherein activation of the first icon causes display, via the one or more display generation components, of a user interface of the first application; and a second icon of a second application that is different from the first application, wherein activation of the second icon causes display, via the one or more display generation components, of a user interface of the second application; means, while displaying the first user interface that includes the plurality of icons, for detecting, via the one or more input devices, a first input; means, responsive to detecting the first input and in accordance with a determination that the first input corresponds to a first request, for displaying, via the one or more display generation components, a second user interface that includes a plurality of application category options, wherein the plurality of application category options includes: a first category option that corresponds to a first set of applications with a first shared characteristic that includes having an unread notification; and a second category option that corresponds to a second set of applications with a second shared characteristic that is different from the first shared characteristic, wherein the second set of applications is different from the first set of applications; means, while displaying the second user interface that includes the plurality of application category options, for detecting, via the one or more input devices, a second input; and means, responsive to detecting the second input, for: in accordance with a determination that the second input activates the first category option, displaying, via the one or more display generation components, application icons of the first set of applications with the first shared characteristic that includes having an unread notification; and in accordance with a determination that the second input activates the second category option, displaying, via the one or more display generation components, application icons of the second set of applications with the second shared characteristic.

In some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a first user interface that includes a plurality of icons, wherein the plurality of icons includes: a first icon of a first application, wherein activation of the first icon causes display, via the one or more display generation components, of a user interface of the first application; and a second icon of a second application that is different from the first application, wherein activation of the second icon causes display, via the one or more display generation components, of a user interface of the second application; while displaying the first user interface that includes the plurality of icons, detecting, via the one or more input devices, a first input; in response to detecting the first input and in accordance with a determination that the first input corresponds to a first request, displaying, via the one or more display generation components, a second user interface that includes a plurality of application category options, wherein the plurality of application category options includes: a first category option that corresponds to a first set of applications with a first shared characteristic that includes having an unread notification; and a second category option that corresponds to a second set of applications with a second shared characteristic that is different from the first shared characteristic, wherein the second set of applications is different from the first set of applications; while displaying the second user interface that includes the plurality of application category options, detecting, via the one or more input devices, a second input; and in response to detecting the second input: in accordance with a determination that the second input activates the first category option, displaying, via the one or more display generation components, application icons of the first set of applications with the first shared characteristic that includes having an unread notification; and in accordance with a determination that the second input activates the second category option, displaying, via the one or more display generation components, application icons of the second set of applications with the second shared characteristic.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for navigating user interfaces, thereby increasing the effectiveness, efficiency, and user satisfaction with such devices. Such methods and interfaces may complement or replace other methods for navigating user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6K illustrate exemplary user interfaces for updating a folder that includes icons of multiple lightweight applications in accordance with some embodiments.

FIG. 7 is a flow diagram illustrating methods of updating a folder that includes icons of multiple lightweight applications in accordance with some embodiments.

FIGS. 8A-8H illustrate exemplary user interfaces for displaying categories of applications in accordance with some embodiments.

FIGS. 9A-9B are a flow diagram illustrating methods of displaying categories of applications in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for navigating user interfaces. In some embodiments, a folder that includes icons for lightweight application is replaced with an icon for a full application. Such techniques can reduce the cognitive burden on a user who navigate user interfaces, thereby enhancing productivity. Further, such techniques can reduce processor and battery power otherwise wasted on redundant user inputs.

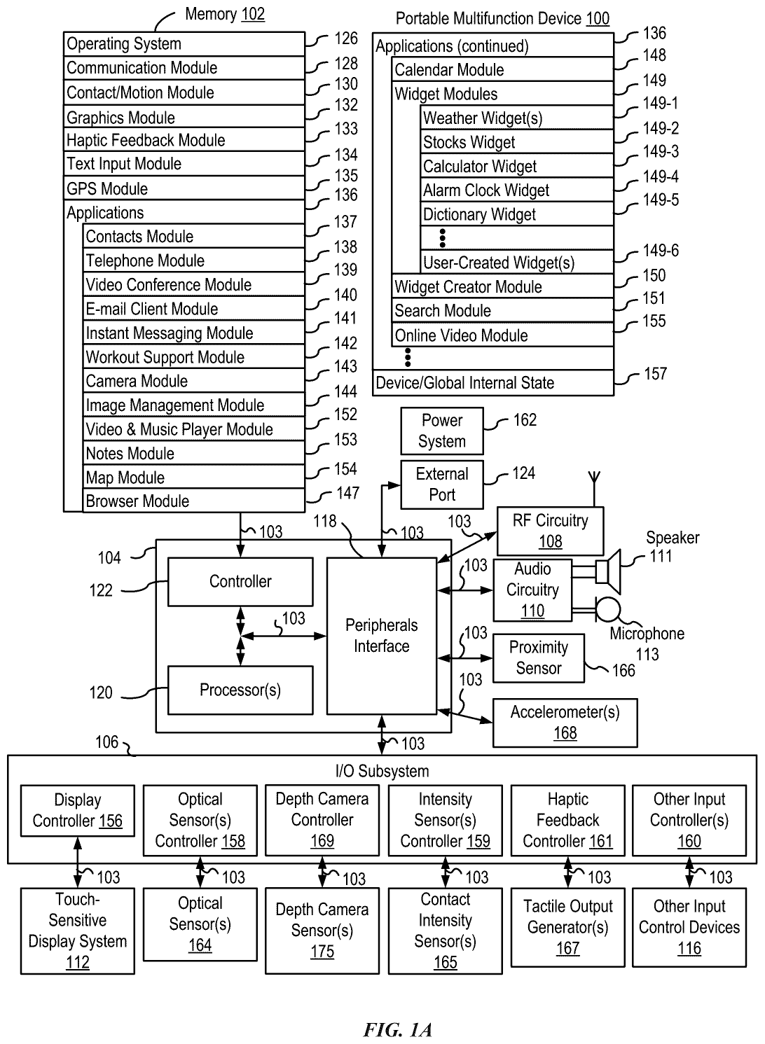

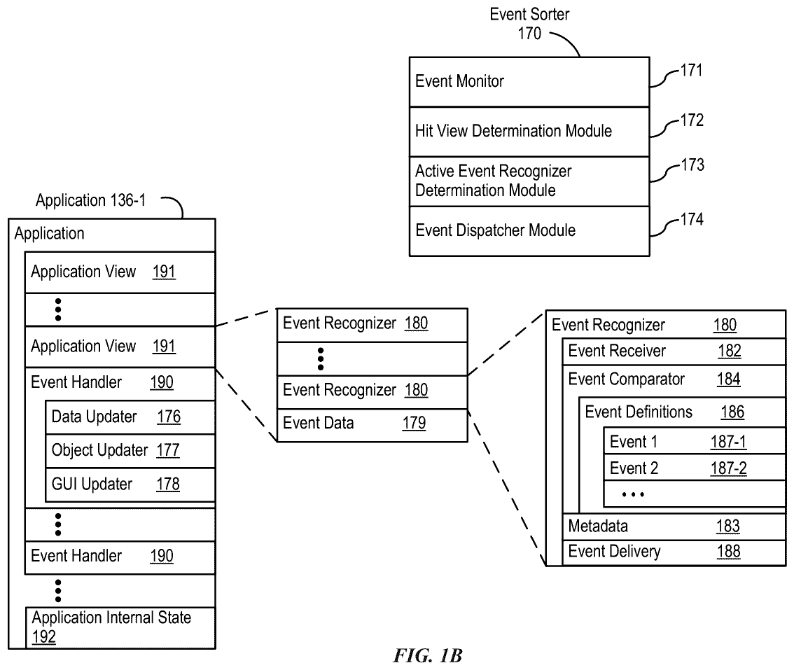

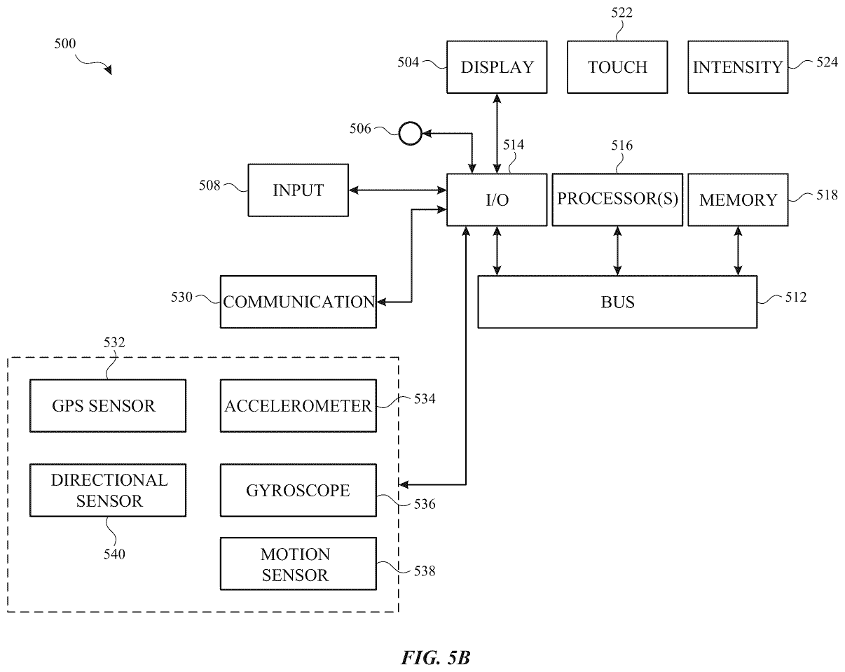

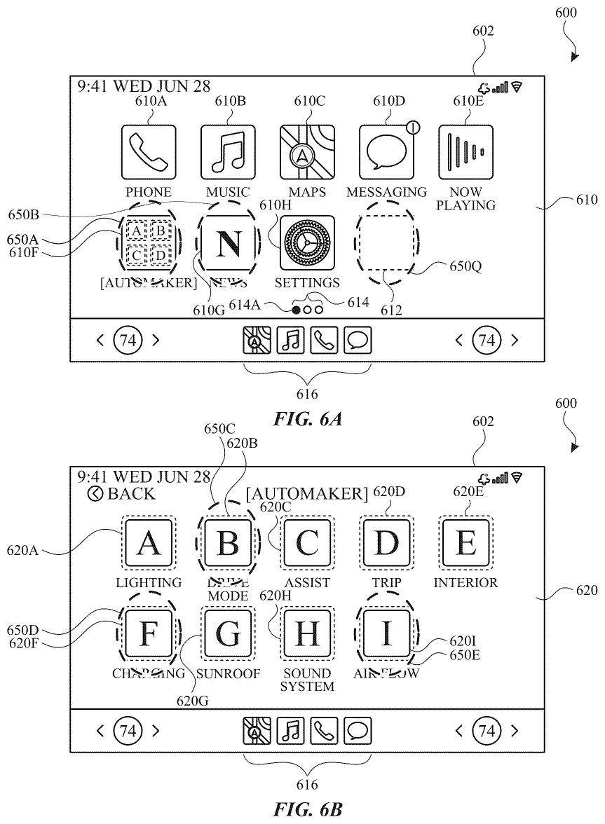

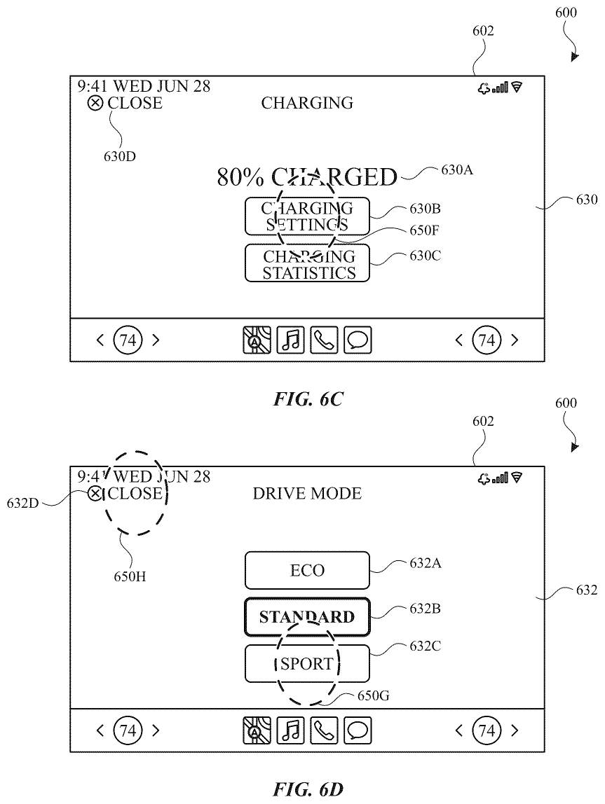

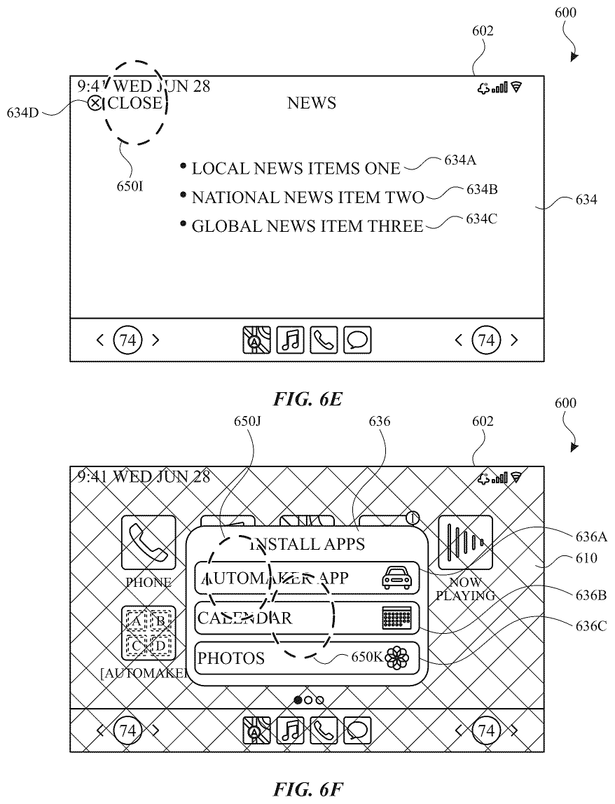

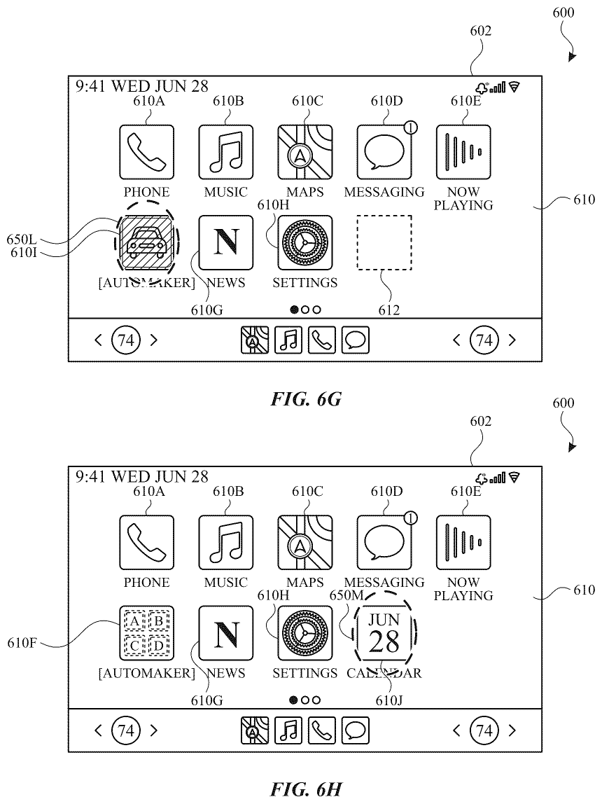

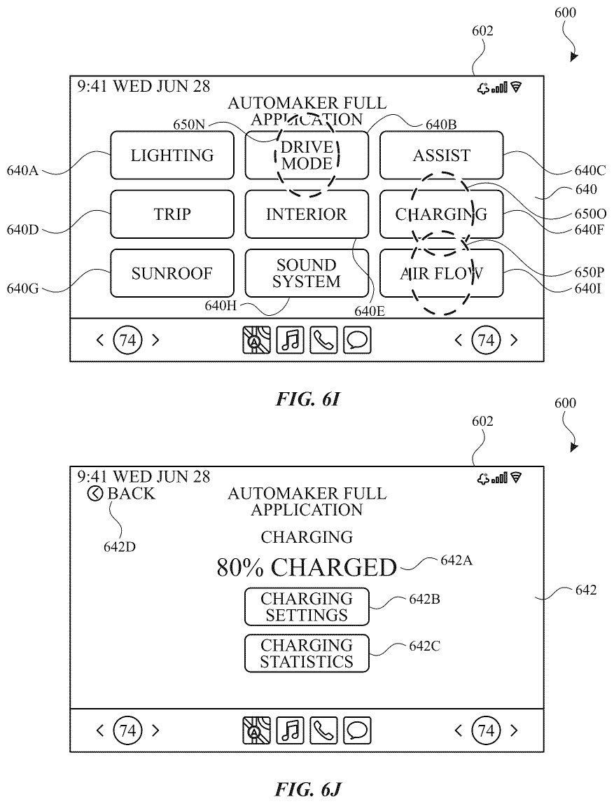

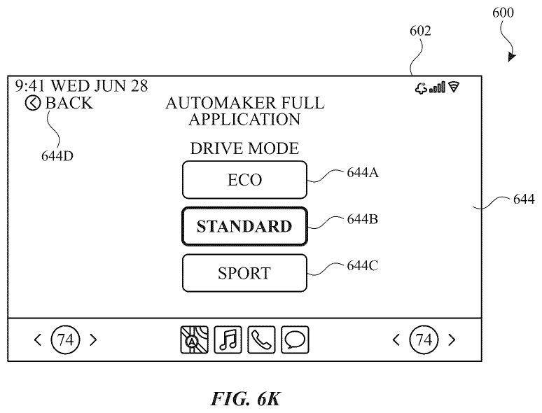

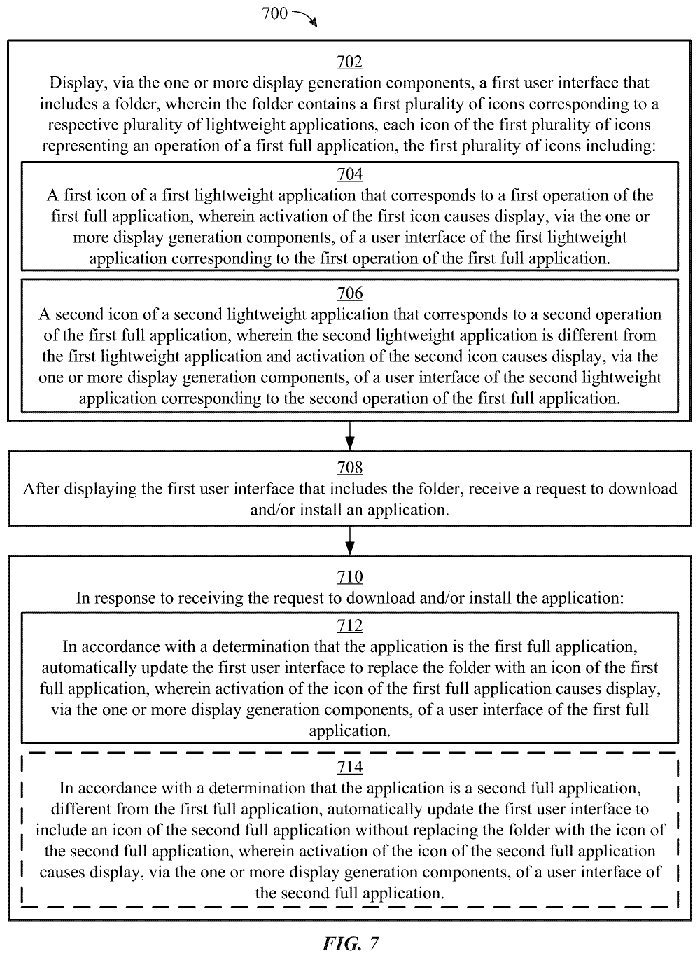

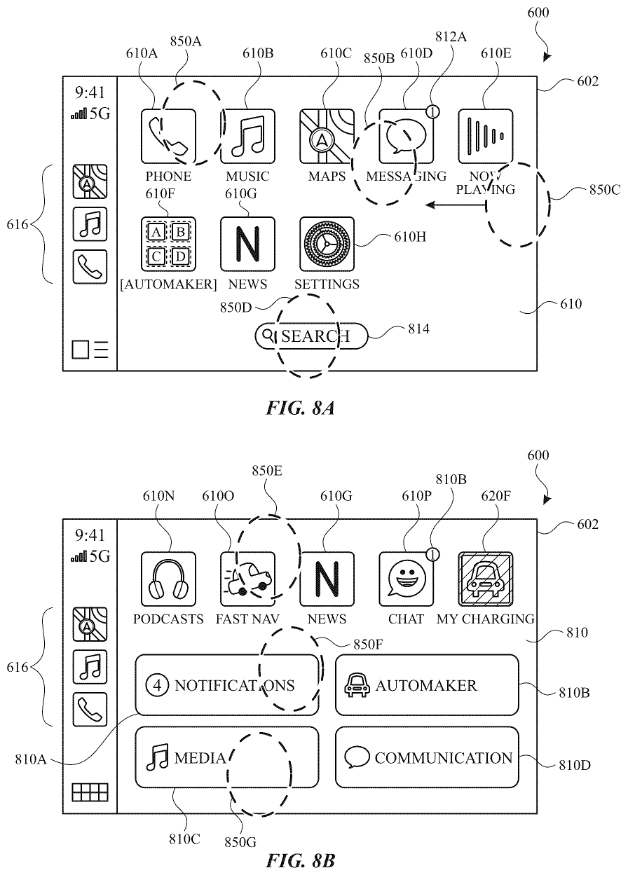

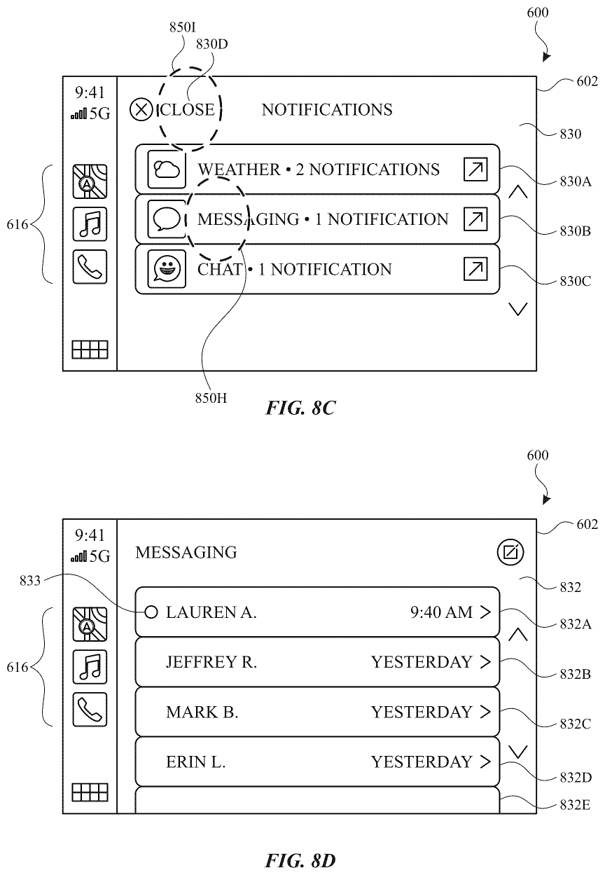

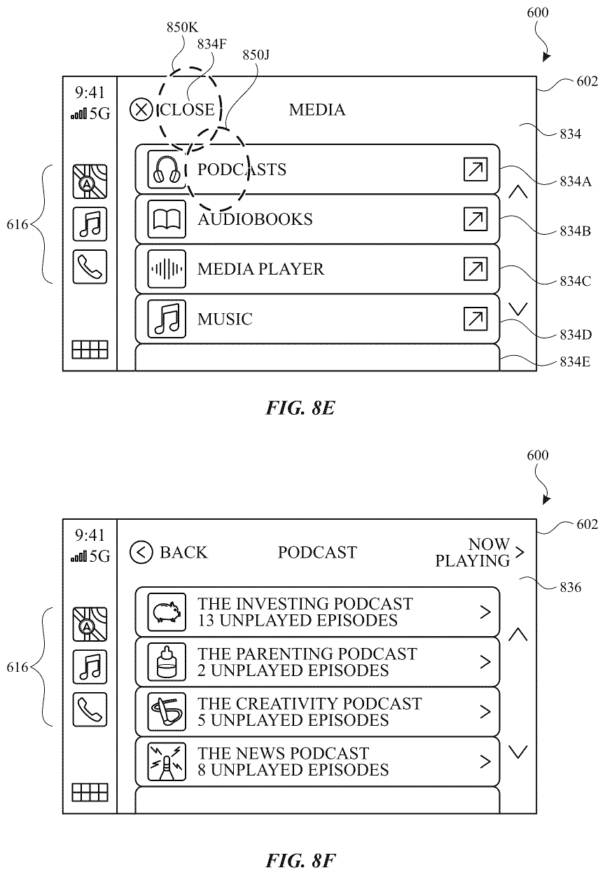

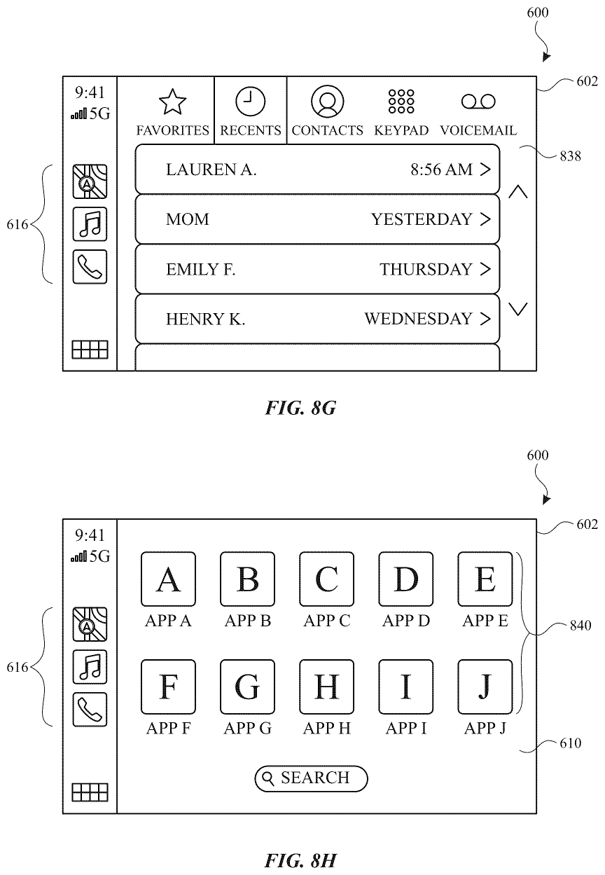

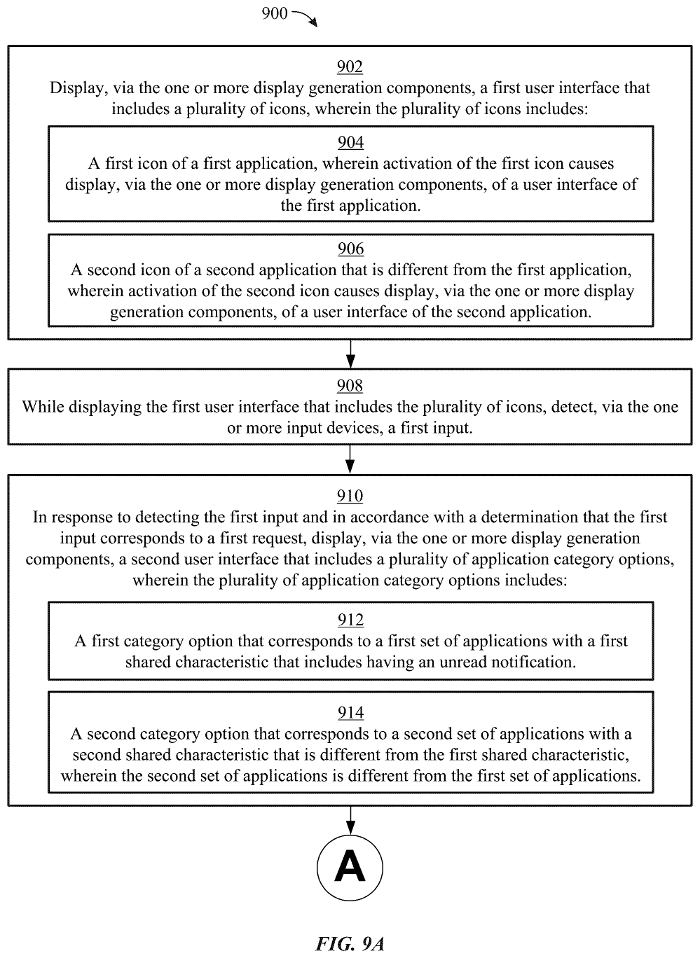

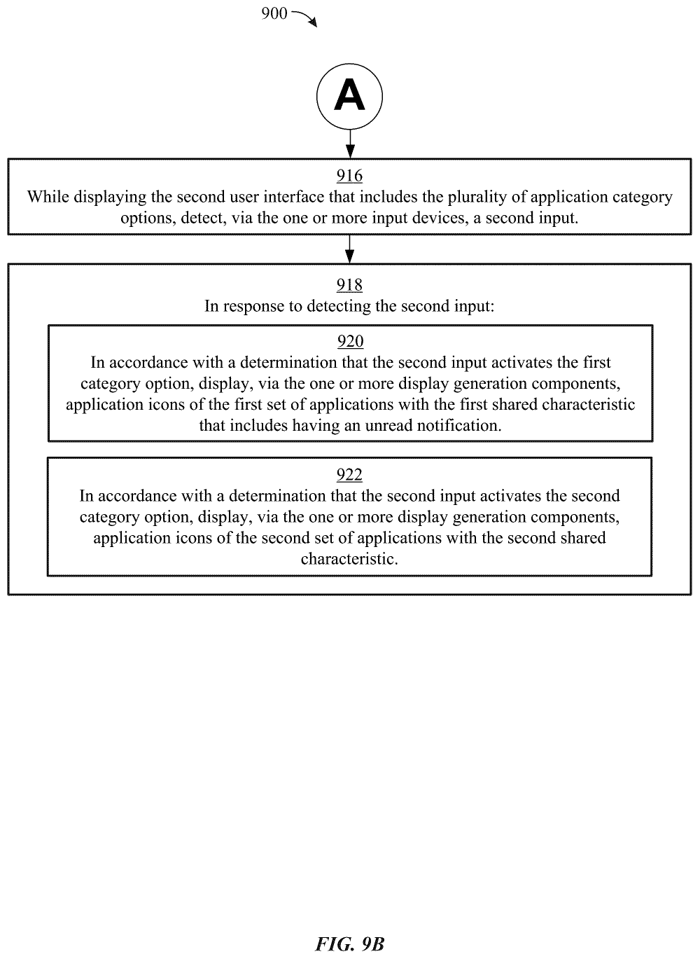

Below, FIGS. 1A-1B, 2, 3A-3G, 4A-4B, and 5A-5B provide a description of exemplary devices for performing the techniques for managing event notifications. FIGS. 6A-6K illustrate exemplary user interfaces for updating a folder that includes icons of multiple lightweight applications in accordance with some embodiments. FIG. 7 is a flow diagram illustrating methods of updating a folder that includes icons of multiple lightweight applications in accordance with some embodiments. The user interfaces in FIGS. 6A-6K are used to illustrate the processes described below, including the processes in FIG. 7. FIGS. 8A-8H illustrate exemplary user interfaces for displaying categories of applications in accordance with some embodiments. FIGS. 9A-9B are a flow diagram illustrating methods of displaying categories of applications in accordance with some embodiments. The user interfaces in FIGS. 8A-8H are used to illustrate the processes described below, including the processes in FIGS. 9A-9B.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

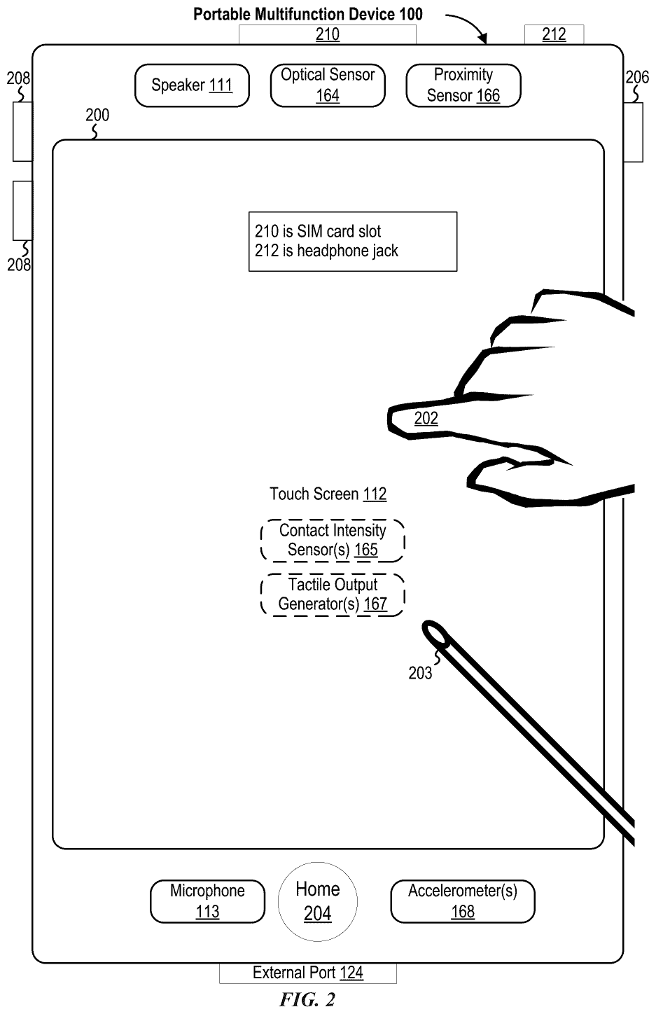

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patents application Ser. Nos. 11/241,839, “Proximity Detector In Handheld Device”; 11/240,788, “Proximity Detector In Handheld Device”; 11/620,702, “Using Ambient Light Sensor To Augment Proximity Sensor Output”; 11/586,862, “Automated Response To And Sensing Of User Activity In Portable Devices”; and 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

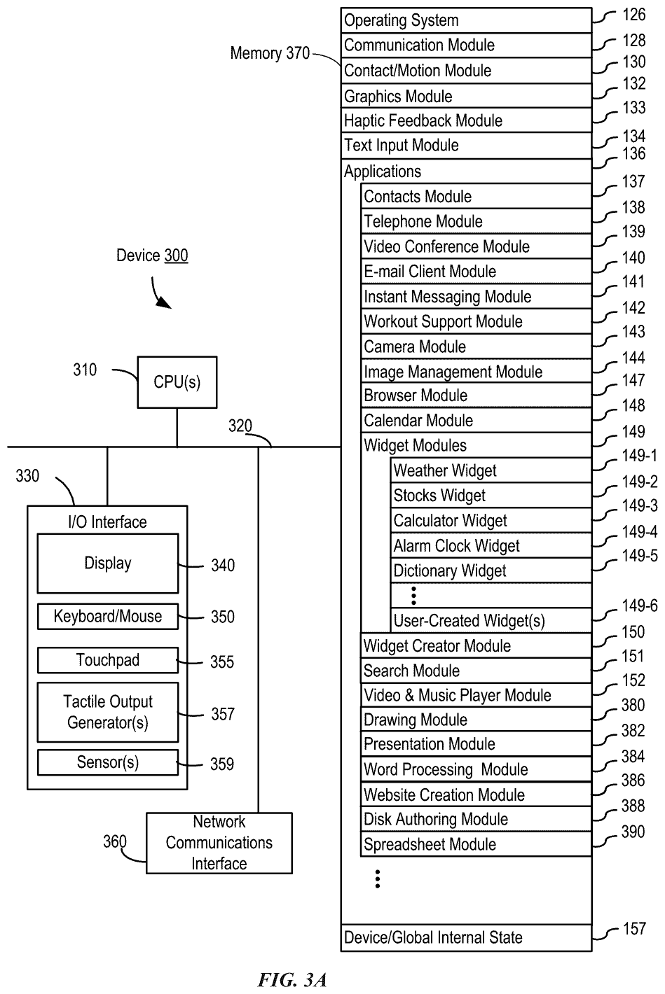

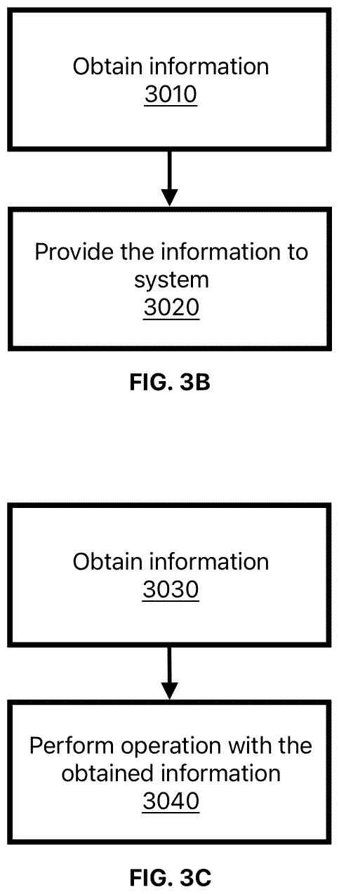

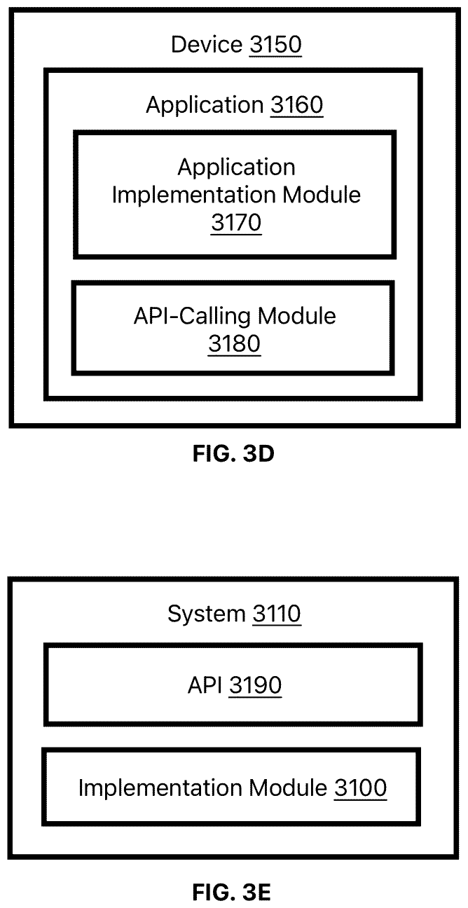

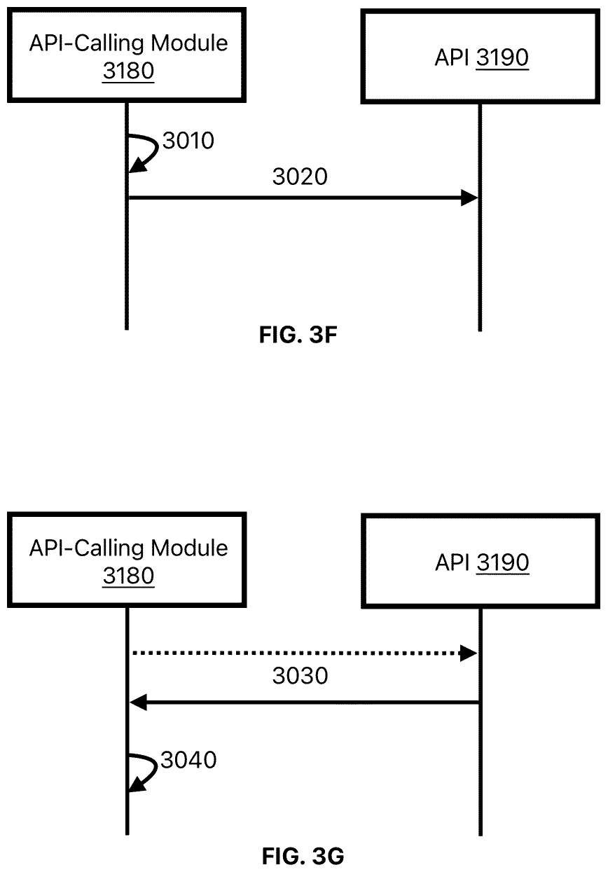

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and/or 900 (FIGS. 7 and/or 9A-9B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

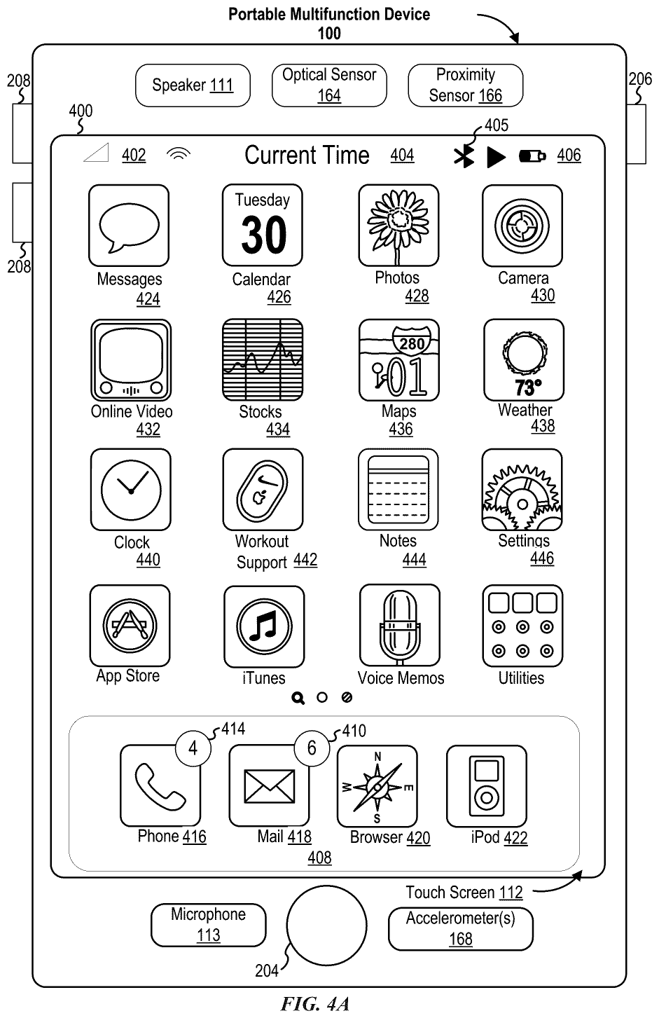

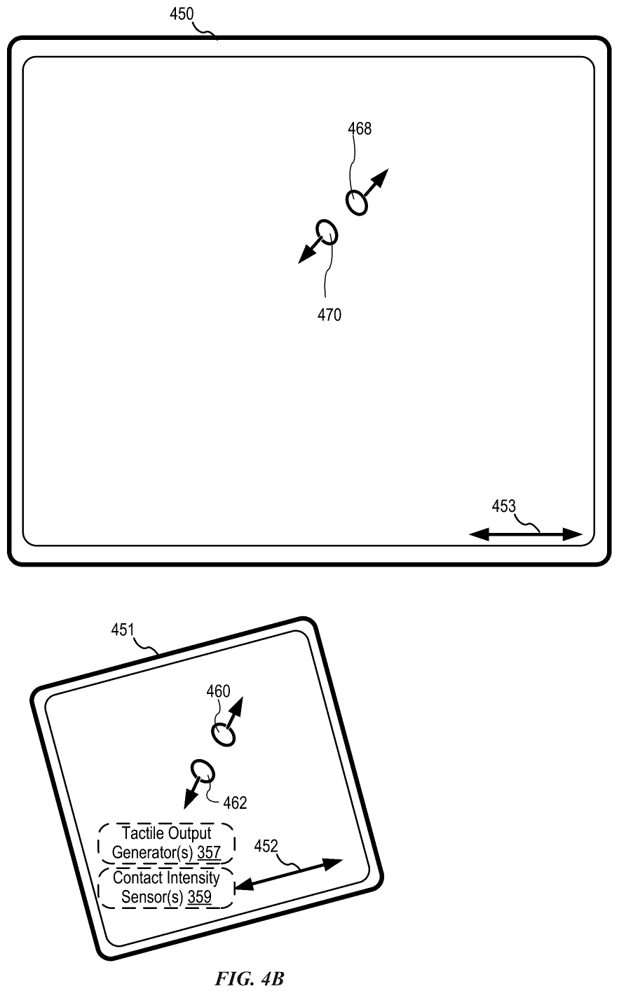

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

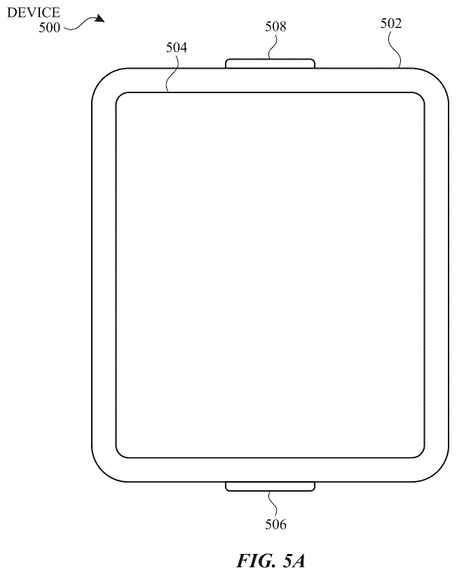

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 (FIGS. 7) and 900 (FIGS. 9A-9B). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, an installed application refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

Attention is now directed towards embodiments of user interfaces (“UI”) and associated processes that are implemented on an electronic device, such as portable multifunction device 100, device 300, or device 500.

FIGS. 6A-6K illustrate exemplary user interfaces for updating a folder that includes icons of multiple lightweight applications, in accordance with some embodiments. The user interfaces in these figures are used to illustrate the processes described below, including the processes in FIG. 7.

FIG. 6A illustrates computer system 600, which includes display 602. In some embodiments, computer system 600 is part of a vehicle and display 602 is integrated into and/or installed in the vehicle. In some embodiments, display 602 is set within a front console (e.g., center console) of the vehicle and/or is a display positioned in the console between a driver's seat and a passenger's seat. In some embodiments, display 602 is part of an infotainment display. In some embodiments, display 602 is a touchscreen display. In some embodiments, display 602 is not a touchscreen display and the computer system is in communication with a physical input device (e.g., a joystick and/or a keyboard) for navigating the user interfaces displayed on display 602. In some embodiments, computer system 600 includes one or more features of devices 100, 300, and/or 500.

At FIG. 6A, computer system 600 is displaying, via display 602, home user interface 610. Home user interface 610 includes an arrangement of user interface objects 610A-610H. In this example, the arrangement includes two rows and multiple columns. The arrangement optionally includes icons of applications (e.g., non-lightweight applications and/or full applications), icons of lightweight applications, and folders, each in a particular position within the arrangement. In some embodiments, the arrangement includes multiple pages, as indicated by page indicators 614.

In some embodiments, a lightweight application is a lightweight version of a corresponding full application. In some embodiments, the lightweight application includes some, but not all, functionality of the full application. In some embodiments, the lightweight application is configured to initiate some, but not all, of the same operations as the full application. In some embodiments, multiple lightweight applications correspond to the same full application, such that a first lightweight application includes a first set of functionalities and/or a first set of operations that are in the full application and a second lightweight application includes a second set of functionalities and/or operations (different from the first set) that are in the full application. In some embodiments, each lightweight application corresponding to a full application can be executed independently from other lightweight applications that correspond to the same full application and independently from the full application (e.g., there is no need to download the other lightweight applications or the full application). In some embodiments, a lightweight application is a small (less than whole) portion of the corresponding full application. In some embodiments, a lightweight application and a corresponding full application include the same (and/or corresponding) computer program code for the same functionalities and/or operations. For example, respective computer program code of the lightweight application is used to display an option and to initiate an operation and the same respective computer code is used in the corresponding full application to display the same (or corresponding) option and to initiate the same (or a corresponding) operation.

Phone icon 610A, when activated (e.g., via a tap or tap-and-hold input), causes computer system 600 to display a user interface of an audio communication (e.g., phone) application. Music icon 610B, when activated, causes computer system 600 to display a user interface of a media (e.g., music) application. Maps icon 610C, when activated, causes computer system 600 to display a user interface of a maps (e.g., navigation) application. Messaging icon 610D, when activated, causes computer system 600 to display a user interface of an instant messaging (e.g., SMS and/or chat) application. Now playing icon 610E, when activated, causes computer system 600 to display a user interface of an active and currently playing media (e.g., audio and/or video) application. Folder 610F is a folder that includes a plurality of icons of lightweight applications that correspond to a vehicle application, as described in further detail below. In this example, the visual depiction of folder 610F includes visual representations of several icons of lightweight applications. In other examples, the visual depiction of folder 610F does not include visual representations of icons of lightweight applications and/or includes a graphical element (e.g., an image of a vehicle, an image of a start). Folder 610F, when activated, causes computer system 600 to display icons (e.g., 620A-620I) of the lightweight applications in folder 610F. News icon 610G, when activated, causes computer system 600 to display a user interface of a news application. Settings icon 610H, when activated, causes computer system 600 to display a user interface of a computer settings application. Location 612 indicates a location (within the arrangement of user interface objects) at which an icon for a newly downloaded and/or installed application (that does not replace a folder) would be displayed. The visual depiction of location 612 is included for case of understanding and is not a part of the user interface of computer system 600.

FIG. 6A also illustrates page indicators 614, with first page dot 614A having a distinct visual appearance as compared to the other page dots to indicate that computer system 600 is displaying a first page of home user interface 610.

At FIG. 6A, computer system 600 detects an input (e.g., a tap or tap-and-hold). In accordance with a determination that the input (e.g., 650A) is directed to folder 610F, computer system 600 displays user interface 620, as shown in FIG. 6B. In accordance with a determination that the input (e.g., 650B) is directed to news icon 610G, computer system 600 displays user interface 634 of the news application, as shown in FIG. 6E. In accordance with a determination that the input (e.g., 650Q) is directed to location 612, computer system 600 does not display a different user interface because there is no folder or icon at location 612.

At FIG. 6B, in response to detecting input 650A directed to folder 610F (at FIG. 6A), computer system 600 displays folder user interface 620 that includes the contents of folder 610F. Folder 610F (and therefore folder user interface 620) includes icons 620A-620I of a plurality of lightweight applications. The lightweight applications of the plurality of lightweight applications correspond to a vehicle application (e.g., that is a full application). In some embodiments, folder 610F only includes icons of applications that are lightweight applications that correspond to the vehicle application (e.g., with user interface 640). In some embodiments, folder 610F includes user interface objects (e.g., icons and/or folders) other than icons of lightweight applications that correspond to the vehicle application. The plurality of lightweight applications are configured to perform the same operations (e.g., automatically and/or based on user input) as the vehicle application is configured to perform.

At FIG. 6B, while the contents of folder 610F are displayed as part of folder user interface 620, activating a respective icon of icons 620A-620I causes computer system 600 to display a user interface of the corresponding respective lightweight application. For example, computer system 600 detects an input (e.g., a tap or tap-and-hold). In accordance with a determination that the input (e.g., 650C) is directed to drive mode icon 620B, computer system 600 displays user interface 632 of a drive mode lightweight application, as shown in FIG. 6D. In accordance with a determination that the input (e.g., 650D) is directed to charging icon 620F, computer system 600 displays user interface 630 of a charging lightweight application, as shown in FIG. 6C. In accordance with a determination that the input (e.g., 650E) is directed to air flow icon 620I, computer system 600 displays a user interface of the air flow lightweight application. Although icons 620A-620I are each illustrated as depicting a letter of the alphabet, the icons can instead, or in addition, include other graphical elements (e.g., drawings, photos, images, and/or animations).

At FIG. 6C, in response to detecting input 650D, computer system 600 displays user

interface 630 of the charging lightweight application (e.g., which is already installed on computer system 600). User interface 630 includes indication 630A of the current charge of the vehicle, charge settings option 630B, and charge statistics option 630C. In some embodiments, input 650D activating charging icon 620F causes computer system 600 to query a battery and/or other component of the vehicle to determine a percent charge (e.g., of the vehicle battery), to be displayed as indication 630A. Activation of options 630B-630C similarly causes a respective operation to be performed. For example, computer system 600 detects input 650F directed to charge settings option 630B and, in response, initiates an operation to change charging settings (e.g., maximum charge, charge schedule, and/or charge rate) of the vehicle. Activation of close option 630D causes computer system 600 to close (e.g., cease to display) user interface 630 and return to displaying folder user interface 620, as shown in FIG. 6B.

At FIG. 6D, in response to detecting input 650C, computer system 600 displays user interface 632 of the drive mode lightweight application (e.g., which is already installed on computer system 600). User interface 632 includes eco drive mode option 632A, standard drive mode option 632B, and sport drive mode option 632C. Computer system 600 displays standard drive mode option 632B with a different visual characteristic (e.g., a bolded border) as compared to options 632A and 632C to indicate that the vehicle is currently in the standard drive mode. In some embodiments, computer system 600 detects input 650D that activates sport drive mode option 632C and, in response, computer system 600 changes the drive mode of the vehicle to the sport drive mode (and, optionally, bolds the border of sport drive mode option 632C). Activation of option 632A similarly causes a respective operation (change to eco drive mode) to be performed. Activation of close option 632D, via input 650H (e.g., a tap input or tap-and-hold input), causes computer system 600 to close (e.g., cease to display) user interface 632 and return to displaying folder user interface 620, as shown in FIG. 6B.

At FIG. 6E, in response to detecting input 650B directed to news icon 610G (at FIG. 6A), computer system 600 displays user interface 634 of the news application (e.g., which is already installed on computer system 600). In some embodiments, the news application is not a lightweight application that corresponds to the vehicle application (e.g., does not share overlapping functionality or perform overlapping operations). In some embodiments, the news application is a lightweight application that corresponds to a full application other than the vehicle application. In some embodiments, the news application is a full application. At FIG. 6E, user interface 634 includes news items 634A-634C. Activation of close option 634D, via input 650I (e.g., a tap input or tap-and-hold input), causes computer system 600 to close (e.g., cease to display) user interface 634 and return to displaying home user interface 610, as shown in FIG. 6A.

At FIG. 6F, computer system 600 displays installation options user interface 636. In some embodiments, installation options user interface 636 is displayed in response to computer system 600 receiving a request (e.g., a user request and/or a system request). Installation options user interface 636 includes first option 636A to download and/or install the vehicle application (a full application that corresponds to the lightweight applications described with respect to FIGS. 6B-6D), second option 636B to download and/or install a calendar application (e.g., full application that does not correspond to the lightweight applications described with respect to FIGS. 6B-6D), and third option 636C to download and/or install a photos application.

At FIG. 6F, computer system 600 receives a user input (e.g., 650J or 650K). In response to receiving the user input and in accordance with a determination that the user input (e.g., 650J) is directed to first option 636A, computer system 600 downloads and/or installs the vehicle application. The vehicle application is a full application that includes the functionality and/or is configured to perform the same operations as the lightweight applications (and therefore corresponds to the lightweight applications) with icons in folder 610F (e.g., icons displayed as part of folder user interface 620). Accordingly, as shown in FIG. 6G, in response to receiving user input 650J, computer system 600 replaces folder 610F (and, optionally, the contents of folder 610F) with icon 610I of the vehicle application. Replacing folder 610F with icon 610I of the vehicle application enables computer system 600 to provide the user with access to the same functionalities and operations of the lightweight applications at the same location within the arrangement of home user interface 610. At FIG. 6G, computer system 600 does not display icon 610I at location 612. As shown in FIG. 6G, the arrangement of user interface objects 610A-610H remains the same in user interface 610, other than icon 610I being displayed at the location in home user interface 610 that was previously occupied by folder 610F. In some embodiments, computer system 600 deletes folder 610F and the contents of folder 610F. In some embodiments, the vehicle application is downloaded and/or installed without computer system 600 receiving a user request to download and/or install the vehicle application. At FIG. 6G, computer system 600 detects input 650L directed to icon 610I of the vehicle application and, in response, computer system 600 displays user interface 640 of the vehicle application, as shown in FIG. 6I.

At FIG. 6F, in response to receiving the user input and in accordance with a determination that the user input (e.g., 650K) is directed to second option 636B, computer system 600 downloads and/or installs the calendar application. The calendar application is not a full application that includes the functionality and/or operations of the lightweight applications with icons in folder 610F (e.g., icons displayed as part of folder user interface 620). Accordingly, as shown in FIG. 6H, computer system 600 does not replace folder 610F with icon 610J of the calendar application. Instead, icon 610J of the calendar application is displayed (e.g., concurrently with folder 610F) at location 612 as was indicated at FIG. 6A. Thus, computer system 600 continues to provide the user with access to the same functionalities and/or operations of the lightweight applications at the same location (and via the same folder 610F that provide access to the lightweight applications). In some embodiments, the calendar application is downloaded and/or installed without computer system 600 receiving a user request to download and/or install the calendar application. At FIG. 6G, computer system 600 detects input 650M directed to icon 610J of the calendar application and, in response, computer system 600 displays a user interface of the calendar application.

At FIG. 6I, in response to detecting (at FIG. 6G) input 650L directed to icon 610I of the vehicle application, computer system 600 displays user interface 640 of the vehicle application. The vehicle application enables the user to perform the same operations as was previously enabled by the plurality of lightweight applications (e.g., operations that change the state of the vehicle and/or operations that modify a setting of the vehicle). In some embodiments, the vehicle application enables the user to perform additional operations (e.g., that were not enabled by the lightweight applications) as compared to the operations enabled by the lightweight applications. At FIG. 6I, user interface 640 includes options 640A-640I, which correspond to respective icons 620A-620I. In some embodiments, user interface 640 is structured differently (e.g., user interface 640 includes user interface elements 642A-642C and 644A-644C and does not include options 640B and 640F). At FIG. 6I, computer system 600 receives user input directed to a respective option of user interface 640 and, in response, displays corresponding options and/or performs a corresponding operation (or initiates a process to perform the corresponding operation). For example, in response to computer system 600 detecting input 650N directed to drive mode option 640B, computer system 600 displays user interface 642 of the vehicle application, as shown in FIG. 6J. For example, in response to computer system 600 detecting input 6500 directed to charging option 640F, computer system 600 displays user interface 644 of the vehicle application, as shown in FIG. 6K. For example, in response to computer system 600 detecting input 650P directed to air flow option 640I, computer system 600 displays a user interface that enables the same (or the same and more) operations as the corresponding air flow lightweight application (discussed with reference to FIG. 6B).

At FIG. 6J, computer system 600 displays user interface 642 of the vehicle application. User interface 642 enables the user to initiate the same operations as was enabled via the charging lightweight application (e.g., shown in FIG. 6C). For example, user interface 642 includes an indication 642A (e.g., corresponding to indication 630A) of the current charge of the vehicle, charge settings option 642B (e.g., corresponding to charge settings option 630B), and charge statistics option 642C (e.g., corresponding to charge statistics option 630C). In some embodiments, an input activating charging option 640F (at FIG. 6I) causes computer system 600 to query a battery of the vehicle to determine the percent charge, to be displayed as indication 642A. Activation of options 642B-642C causes a respective operation to be performed (or initiating a process to perform the respective operation). For example, computer system 600 detects an input directed to charge settings option 642B and, in response, initiates an operation to change charging settings (e.g., maximum charge, charge schedule, and/or charge rate) (e.g., the same operation as discussed with respect to charge settings option 630B) of the vehicle. Activation of back option 642D causes computer system 600 to navigate back to user interface 640, as shown in FIG. 6I.

At FIG. 6K, computer system 600 displays user interface 644 of the vehicle application. User interface 644 enables the user to initiate the same operations as was enabled via the drive mode lightweight application (e.g., shown in FIG. 6D). For example, user interface 644 includes eco drive mode option 644A (e.g., corresponding to eco drive mode option 632A), standard drive mode option 644B (e.g., corresponding to standard drive mode option 632B), and sport drive mode option 644C (e.g., corresponding to sport drive mode option 632C). Computer system 600 displays standard drive mode option 644B with a different visual characteristic (e.g., a bolded border, same as with standard drive mode option 632B) as compared to options 644A and 644C to indicate that the vehicle is currently in the standard drive mode. In some embodiments, computer system 600 detects an input that activates sport drive mode option 644C and, in response, computer system 600 changes the drive mode of the vehicle to the sport drive mode (and, optionally, bolds the border of sport drive mode option 644C) (e.g., performing the same operation as described with respect to input 650G directed to sport drive mode option 632C at FIG. 6D). Activation of option 644A similarly causes a respective operation (change to eco drive mode) to be performed (e.g., the same operation performed as when 632A is activated). Activation of back option 644D causes computer system 600 to navigate back to user interface 640, as shown in FIG. 6I.

FIG. 7 is a flow diagram illustrating a method for updating a folder that includes icons of multiple lightweight applications using a computer system in accordance with some embodiments. Method 700 is performed at a computer system (e.g., 100, 300, 500, and/or 600) (e.g., a smartphone, a wearable (e.g., head-mounted) device, and/or of a vehicle (e.g., an automobile, a boat, or an airplane)), wherein the computer system is in communication with one or more display generation components (e.g., one or more display generation components of the vehicle, one or more displays set within a front console of the vehicle, one or more displays positioned ahead of/in front of a driver's seat of the vehicle, one or more heads-up displays, one or more display drivers, and/or one or more displays of a wearable device) and, optionally, one or more input devices (a touch-sensitive surface, an input device (e.g., a joystick, a scroll wheel, a button, and/or a touch-sensitive surface) (e.g., integrated into a steering wheel of the vehicle), one or more cameras (e.g., for detecting gestures performed in the air), and/or a microphone): In some embodiments, the computer system is in communication with a vehicle (e.g., an automobile, a boat, or an airplane) (e.g., is integrated into the vehicle, is in wired communication with the vehicle, and/or is in wireless communication with the vehicle). Some operations in method 700 are, optionally, combined, the orders of some operations are, optionally, changed, and some operations are, optionally, omitted.

As described below, method 700 provides an intuitive way for updating a folder that includes icons of multiple lightweight applications. The method reduces the cognitive burden on a user for accessing applications, thereby creating a more efficient human-machine interface. For battery-operated computing devices, enabling a user to access applications faster and more efficiently conserves power and increases the time between battery charges.

The computer system (e.g., 600) displays (702) (e.g., while a full application corresponding to a first and second lightweight application is not downloaded and/or installed on the computer system), via the one or more display generation components (e.g., 602) (e.g., as part of a center console and/or media console (e.g., of the vehicle)), a first user interface (e.g., 610) (e.g., a home user interface that includes a plurality of application icons) that includes a folder (e.g., 610F), wherein the folder (e.g., 610F) contains a first plurality of (e.g., 2, 3, or 8) icons (e.g., 620A-620I) corresponding to a respective plurality of lightweight applications, each icon of the first plurality of icons (e.g., 620A-620I) representing an operation (or multiple operations) of a first full application (e.g., application of user interface 640).

The first plurality of icons includes a first icon (704) (e.g., 620B) of a first lightweight application (e.g., lightweight application with user interface 632) and a second icon (706) (e.g., 620F) of a second lightweight application (e.g., that is different from the first lightweight application) (e.g., lightweight application with user interface 630). The first lightweight application corresponds to a first operation (e.g., a charging operation, such as 630A-630C) of the first full application (and, optionally, does not correspond to a second full application that is different from the first full application), wherein activation (e.g., 650C) of (e.g., a tap input on and/or a selection of) the first icon (e.g., 620B) causes display, via the one or more display generation components, of a user interface (e.g., 632) of the first lightweight application corresponding to the first operation of the first full application. The second lightweight application (e.g., lightweight application with user interface 630) corresponds to a second operation (e.g., a drive mode operation, such as 632A-632C) of the first full application (and, optionally, does not correspond to the second full application), wherein the second lightweight application is different from the first lightweight application and activation (e.g., 650D) of (e.g., a tap input on and/or a selection of) the second icon (e.g., 620F) causes display, via the one or more display generation components, of a user interface (e.g., 630) of the second lightweight application corresponding to the second operation of the first full application.

After (e.g., concurrently with) displaying the first user interface (e.g., 610) (e.g., the home user interface) that includes the folder, the computer system (e.g., 600) receives (708) a request (e.g., 650J and/or 650K) (e.g., a manual request and or an automated request that does not require user input) to download and/or install (e.g., automatically or in response to user input requesting to download and/or install) an application (e.g., a first full application and/or a second full application).

In response (710) to receiving the request (e.g., 650J and/or 650K) to download and/or install the application and in accordance with a determination that the application is the 1613379205 first full application, the computer system (e.g., 600) automatically updates (712) the first user interface (e.g., 610) (e.g., the home user interface) to replace the folder (e.g., 610F) with an icon (e.g., 610I) of the first full application, wherein activation (e.g., 650L) of (e.g., a tap input on and/or a selection of) the icon (e.g., 610I) of the first full application causes display, via the one or more display generation components (e.g., 602), of a user interface (e.g., 640) of the first full application (e.g., wherein the user interface of the first full application includes options for performing the first operation and the second operation). In some embodiments, in response to receiving the request to download and/or install the application and in accordance with the determination that the application is the first full application, the computer system downloads and/or installs the first full application, thereby causing the computer system to replace the folder with the icon of the first full application. Replacing display of the folder that includes the lightweight applications with the icon of the first full application allows the computer system to continue to provide access to the user to the same functionalities (as was available in the lightweight applications and is now available in the first full application) from the same location, thereby reducing the need for the user to provide additional inputs to search for and/or navigate to the newly installed first full application.

In some embodiments, in response (710) to receiving the request (e.g., 650J and/or 650K) to download and/or install the application and in accordance with a determination that the application is a second full application, different from the first full application, the computer system (e.g., 600) automatically updates (714) the first user interface (e.g., 610) (e.g., the home user interface) to include an icon (e.g., 610J) of the second full application without replacing the folder (e.g., 610F) with the icon (e.g., 610J) of the second full application, wherein activation (e.g., 650M) of (e.g., a tap input on and/or a selection of) the icon (e.g., 610J) of the second full application causes display, via the one or more display generation components (e.g., 602), of a user interface of the second full application. In some embodiments, the icon of the second full application does not replace the folder because the second full application does not include the functionalities and/or access to the same operations of the respective plurality of lightweight applications. In some embodiments, in response to receiving the request to download and/or install the application and in accordance with the determination that the application is the second full application, the computer system downloads and/or installs the second full application, thereby causing the computer system to display the icon of the second full application. Displaying the icon of the second full application without replacing the folder enables the computer system to provide the user with access to the second full application without removing access to the respective plurality of lightweight applications, thereby improving the man-machine interface.

In some embodiments, while displaying the first user interface (e.g., 610) (e.g., the home user interface) with the folder (e.g., 610F) (e.g., prior to replacing the folder with the first full application) (e.g., without displaying the first icon of the first lightweight application and/or the second icon of the second lightweight application), the computer system (e.g., 600) detects activation (e.g., 650A) of (e.g., a tap input on or selection of) the folder (e.g., 610F) that contains the first plurality of (e.g., 2, 3, or 8) icons (e.g., 620A-620I) corresponding to the respective plurality of lightweight applications. In response to detecting activation (e.g., 650A) of the folder (e.g., 610F), the computer system (e.g., 600) displays (e.g., concurrently displaying), via the one or more display generation components (e.g., 602) (e.g., by replacing display of the folder): the first icon (e.g., 620B) of the first lightweight application and the second icon (e.g., 620F) of the second lightweight application. Displaying the first plurality of icons (including the icons for the first and second lightweight applications) provides the user with visual feedback about the available lightweight applications in the folder and gives the user access to the lightweight applications (and their functions and/or to the ability to perform operations of the lightweight applications).

In some embodiments, the computer system (e.g., 600) detects (e.g., while displaying the first icon of the first lightweight application and the second icon of the second lightweight application) an activation input (e.g., 650C-650D) (e.g., a tap input and/or a selection input). In response to detecting the activation input and in accordance with a determination that the activation input (e.g., 650C) is directed to the first icon (e.g., 620B) of the first lightweight application (e.g., without displaying the UI of the second lightweight application), the computer system (e.g., 600) displays, via the one or more display generation components (e.g., 602) (e.g., by replacing display of the first icon of the first lightweight application), a user interface (e.g., 632) of the first lightweight application, wherein the user interface of the first lightweight application includes an option (e.g., 632A-632C) to perform (e.g., when the option is activated) the first operation (e.g., configure charging settings, view charging statistics, display a vehicle drive mode (e.g., eco, standard, sport), and/or modify a vehicle drive mode). In response to detecting the activation input and in accordance with a determination that the activation input (e.g., 650D) is directed to the second icon (e.g., 620F) of the second lightweight application, the computer system displays, via the one or more display generation components (e.g., by replacing display of the first icon of the first lightweight application), a user interface (e.g., 630) of the second lightweight application (e.g., without displaying the UI of the first lightweight application), wherein the user interface (e.g., 630) of the second lightweight application includes an option (e.g., 632A-632C) to perform (e.g., when the option is activated) a second operation (e.g., configure charging settings, view charging statistics, display a vehicle drive mode (e.g., eco, standard, sport), and/or modify a vehicle drive mode) that is different from the first operation. Activating a respective lightweight application provides the user with the UI of the respective lightweight application, thereby providing visual feedback about the activated icon and providing the user with access to the functions/operations of the respective lightweight application.

In some embodiments, the computer system (e.g., 600) detects activation (e.g., 650L) of (e.g., a tap input on and/or selection of) the icon (e.g., 610I) of the first full application. In response to detecting activation of the icon (e.g., 610I) of the first full application, the computer system displays, via the one or more display generation components (e.g., 602), a user interface (e.g., 640) of the first full application. Activating the first full application provides the user with the UI of the first full application, thereby providing visual feedback about the activated icon and providing the user with access to the functions/operations of the first full application.

In some embodiments, the first full application is configured to provide (e.g., via one or more user interfaces) the first operation (e.g., 632A-632C) of the first lightweight application and the second operation (e.g., 630A-630C) of the second lightweight application. In some embodiments, the first full application is configured to provide (e.g., via one or more user interfaces) at least a portion of the functionality/operations of each of the plurality of lightweight applications. Providing some of the functionality and/or access to operations from the first and second lightweight applications in the first full application enables the computer system to provide the functionality and/or operations to the user once the folder is replaced, thereby improving the man-machine interface.

In some embodiments, the first full application is configured to provide (e.g., via one or more user interfaces) all of the operations (e.g., 632A-632C) of the first lightweight application and all of the operations (e.g., 630A-630C) of the second lightweight application. In some embodiments, the first full application is configured to provide (e.g., via one or more user interfaces) all of the functionality and/or operations of each lightweight application of the respective plurality of lightweight applications. Providing all of the functionality and/or operations of the first and second lightweight applications in the first full application enables the computer system to provide the full functionality/operations of the lightweight applications to the user once the folder is replaced, thereby improving the man-machine interface.

In some embodiments, the first full application is configured to provide more operations than provided by the respective plurality of lightweight applications. Providing additional functionality/operations as compared to the first and second lightweight applications in the first full application enables the computer system to provide more functionality/operations than is in the lightweight applications to the user once the folder is replaced, thereby improving the man-machine interface.

In some embodiments, the computer system (e.g., 600) receives (e.g., subsequent to and/or while displaying the user interface of the first full application) a first set of one or more user inputs (e.g., 650N). In response to receiving the first set of one or more user inputs, the computer system navigates the first full application to access (e.g., display) a user interface (e.g., 644) of the first full application that is configured to initiate the first operation (e.g., 644A-644C) (e.g., includes an option to initiate the first operation). In some embodiments, the user interfaces of the first full application include options for performing operations that correspond to (e.g., is the same as and/or provides more than) at least a portion of (e.g., all or some of) the operations of the first lightweight application. Navigating the first full application to access the same functionality/operations as from the first lightweight applications enables the computer system to provide the functionality/operations to the user once the folder is replaced, thereby improving the man-machine interface.

In some embodiments, the computer system receives (e.g., subsequent to and/or while displaying the user interface of the first full application) a second set of one or more user inputs (e.g., 6500). In response to receiving the second set of one or more user inputs, the computer system navigates the first full application to access (e.g., display) a user interface (e.g., 642) of the first full application that is configured to initiate the second operation (e.g., 642A-642C) (e.g., includes an option to initiate the second operation). In some embodiments, the user interfaces of the first full application include options for performing operations that correspond to (e.g., is the same as and/or provides more than) at least a portion of (e.g., all or some of) the operations of the second lightweight application. Navigating the first full application to access the same functionality/operations as from the second lightweight applications enables the computer system to provide the functionality/operations to the user once the folder is replaced, thereby improving the man-machine interface.

In some embodiments, displaying the first user interface (e.g., 610) (e.g., the home user interface) that includes the folder (e.g., 610F) includes displaying the folder at a first position within an arrangement of user interface objects (e.g., 610A-610H) that includes a plurality of application icons (e.g., 610A-610E and 610G-610H). Displaying the folder as part of an arrangement if icons enables the user to select from among the icons in the arrangement, thereby giving the user access to more functionalities/operations and improving the man-machine interface.

In some embodiments, automatically updating the first user interface (e.g., 610 as in FIG. 6G) (e.g., the home user interface) to replace the folder (e.g., 610F) with the icon (e.g., 610I) of the first full application includes displaying the icon (e.g., 610I) of the first full application at the first position within the arrangement of the user interface objects that includes the plurality of application icons (e.g., 610A-610E and 610G-610H). In some embodiments, the arrangement (e.g., relative positions) of the user interface objects of the first user interface does not change except for replacing the folder with the icon of the first full application. Maintaining the arrangement enables the user to access the different applications and functionalities/operations at the same locations of the home screen before and after the replacement, thereby improving the man-machine interface.

In some embodiments, the arrangement of the user interface objects (e.g., as shown in 610) includes an arrangement that is spread across a plurality of pages (e.g., as indicated by 614) (e.g., two pages, four pages, or eight pages). In some embodiments, a first set of user interface objects (e.g., folders and/or application icons) are displayed on a first page of the arrangement of the user interface objects and a second set of user interface objects (e.g., different from the first set, folders, and/or application icons) are displayed on a second page (different from the first page) of the arrangement of the user interface objects. Maintaining the arrangement across multiple pages enables the user to access the different applications and functionalities/operations at the same locations (even on different pages) of the home screen before and after the replacement, thereby improving the man-machine interface.

In some embodiments, automatically updating the first user interface (e.g., the home user interface) to replace the folder with the icon of the first full application (e.g., as shown in 610 at FIG. 6G) includes ceasing to display (e.g., deleting) the folder (e.g., 610F). In some embodiments, the folder is no longer displayed in the arrangement of the user interface objects. Ceasing to display the folder (e.g., not displaying the folder at a different location on the home screen) opens up space for displaying other information and provides feedback to the user that the folder has been deleted and/or replaced, thereby providing improved feedback.

In some embodiments, automatically updating the first user interface (e.g., the home user interface) to replace the folder with the icon of the first full application (e.g., as shown in 610 at FIG. 6G) includes deleting (e.g., from the computer system) the first icon (e.g., 620B) of the first lightweight application and the second icon (e.g., 620F) of the second lightweight application. In some embodiments, automatically updating the first user interface (e.g., the home user interface) to replace the folder with the icon of the first full application includes deleting (e.g., from the computer system) the first plurality of (e.g., 2, 3, or 8) icons corresponding to a respective plurality of lightweight applications. Deleting the icons of the lightweight applications opens up space for displaying other information and provides feedback to the user that the lightweight applications have been replaced, thereby providing improved feedback.

In some embodiments, in response to receiving the request (e.g., 650J) to download and/or install the application and in accordance with the determination that the application is the first full application, the computer system (e.g., 600) deletes (e.g., from computer system) the first lightweight application and the second lightweight application. In some embodiments, in response to receiving the request to download and/or install the application and in accordance with the determination that the application is the second full application (e.g., not the first full application), forgoing deleting (e.g., from computer system) the first lightweight application and forgoing deleting the second lightweight application. Deleting the lightweight applications frees up computer memory (e.g., of the computer system), thereby improving the computer system.

In some embodiments, in response to receiving the request (e.g., 650J) to download and/or install the application and in accordance with the determination that the application is the first full application: in accordance with a determination that a third icon (e.g., 620I) of a third lightweight application that corresponds to the first full application (and, optionally, does not correspond to a second full application) is in the folder, the computer system (e.g., 600) deletes (e.g., from computer system) the third icon of the third lightweight application (and, optionally, the third lightweight application) and in accordance with a determination that the third icon of the third lightweight application that corresponds to the first full application (and, optionally, does not correspond to a second full application) is not in the folder (e.g., if 620I were displayed at location 612 of user interface 610 at FIG. 6A), the computer system (e.g., 600) forgoes deleting (e.g., from computer system) the third icon (e.g., 620I) of the third lightweight application (and, optionally, forgoing deleting the third lightweight application). In some embodiments, when an icon of a lightweight application that corresponds to the first full application is not in the folder when the first full application is downloaded and/or installed, the computer system does not delete the icon of the third lightweight application when replacing the folder with the icon of the first full application. When an icon has been moved out of the folder, not deleting the moved icon enables the computer system to continue providing the functionality/operations of the lightweight application corresponding to the icon at the same location in the arraignment, thereby providing an improved man-machine interface.

In some embodiments, the first lightweight application and the second lightweight application (and, optionally, the first full application) correspond to (e.g., are specific to, were developed by/on behalf of, are provided by, and/or are for use in vehicles of) a manufacturer of a vehicle in which the computer system (e.g., 600) is installed. In some embodiments, the first lightweight application and the second lightweight application are automatically downloaded to and/or installed on the computer system in response to a first set of one or more conditions being met. In some embodiments, the first set of one or more conditions includes a first condition that is met when the computer system successfully makes an initial Internet connection. In some embodiments, the first set of one or more conditions includes a second condition that is met when the computer system successfully makes an initial connection with a user device (e.g., a smart phone or tablet of a user/owner of the computer system). In some embodiments, the first set of one or more conditions includes a third condition that is met when the computer system is started for the first time (e.g., after manufacture and/or after being reformatted). The lightweight applications corresponding to the manufacturer of the vehicle in which the computer system is installed enables the lightweight applications to control functionality/operations of the vehicle, thereby giving the user more control and providing an improved man-machine interface.

Note that details of the processes described above with respect to method 700 (e.g., FIG. 7) are also applicable in an analogous manner to the methods described below. For example, method 700 optionally includes one or more of the characteristics of the various methods described below with reference to method 900. For example, the first user interface described with respect to method 700 is the same as the first user interface described with respect to method 900. For brevity, these details are not repeated below.

FIGS. 8A-8H illustrate exemplary user interfaces for displaying categories of applications in accordance with some embodiments. The user interfaces in these figures are used to illustrate the processes described below, including the processes in FIGS. 9A-9B.

FIG. 8A illustrates computer system 600, which includes display 602. In some embodiments, computer system 600 is part of a vehicle and/or display 602 is integrated into and/or installed in the vehicle. In some embodiments, display 602 is set within a front console (e.g., center console) of the vehicle and/or is a display positioned in the console between a driver's seat and a passenger's seat. In some embodiments, display 602 is part of an infotainment display of a vehicle. In some embodiments, display 602 is a touchscreen display. In some embodiments, display 602 is not a touchscreen display and the computer system is in communication with a physical input device (e.g., a joystick and/or a keyboard) for navigating the user interfaces displayed on display 602. In some embodiments, computer system 600 includes one or more features of devices 100, 300, and/or 500.

At FIG. 8A, computer system 600 is displaying, via display 602, home user interface 610 (e.g., the same or similar user interface as shown in FIG. 6A). Home user interface 610 includes an arrangement of user interface objects 610A-610H. In this example, the arrangement includes two rows and multiple columns. The arrangement optionally includes icons of applications (e.g., non-lightweight applications and/or full applications), icons of lightweight applications, and folders, each in a particular position within the arrangement. In some embodiments, the arrangement includes multiple pages (e.g., optionally indicated by page indicators 614, as shown in FIG. 6A).

Phone icon 610A, when activated (e.g., via a tap or tap-and-hold input), causes computer system 600 to display user interface 838 of an audio communication (e.g., phone) application, as shown in FIG. 8G. Music icon 610B, when activated (e.g., via a tap or tap-and-hold input), causes computer system 600 to display a user interface of a media (e.g., music) application. Maps icon 610C, when activated (e.g., via a tap or tap-and-hold input), causes computer system 600 to display a user interface of a maps (e.g., navigation) application. Messaging icon 610D, when activated (e.g., via a tap or tap-and-hold input), causes computer system 600 to display user interface 832 of an instant messaging (e.g., SMS and/or chat) application, as shown in FIG. 8D. Now playing icon 610E, when activated (e.g., via a tap or tap-and-hold input), causes computer system 600 to display a user interface of an active and currently playing media (e.g., audio and/or video) application. Folder 610F is a folder that includes a plurality of icons of lightweight applications that correspond to a vehicle application, as described in detail with respect to FIGS. 6A-6K. Folder 610F, when activated (e.g., via a tap or tap-and-hold input), causes computer system 600 to display icons (e.g., 620A-620I) of the lightweight applications in folder 610F (e.g., as shown at FIG. 6B). News icon 610G, when activated (e.g., via a tap or tap-and-hold input), causes computer system 600 to display a user interface of a news application (e.g., as shown in FIG. 6E). Settings icon 610H, when activated (e.g., via a tap or tap-and-hold input), causes computer system 600 to display a user interface of a computer settings application.

FIG. 8A also illustrates search indicator 814. In some embodiments, search indicator 814 optionally changes to page indicators 614 (e.g., when swipe input 850C is detected) to indicate the current page, as described above with respect to page indicators 614 at FIG. 6A.

At FIG. 8A, computer system 600 detects an input (e.g., a tap, tap-and-hold, and/or swipe). In accordance with a determination that the input (e.g., 850A) is directed to phone icon 610A, computer system 600 displays user interface 838, as shown in FIG. 8G. In accordance with a determination that the input (e.g., 850B) is directed to messaging icon 610D, computer system 600 displays messaging user interface 832 of an instant messaging application, as shown in FIG. 8D. As shown in FIG. 8A, messaging icon 610D includes indication 812A that the corresponding messaging application includes a notification (e.g., an unread notification). In accordance with a determination that the input (e.g., 850C) is a swipe input directed at user interface 610, computer system 600 updates user interface 610 to show a second page of icons, as illustrated in FIG. 8H. In accordance with a determination that the input (e.g., 850D) is directed at search option 814, computer system 600 displays user interface 810, as illustrated in FIG. 8B. As shown in FIG. 8A, icons 610A-610C, 610E, 610G, and 610H and folder 610F do not have any unread notifications.

At FIG. 8B, in response to detecting input 850D (e.g., a tap and/or a tap-and-hold) directed to search option 814, computer system 600 displays user interface 810 that includes a plurality of category options (e.g., 810A-810D) and, optionally, a plurality of icons (e.g., 610N, 610O, 610G, 610P, and 620F) of suggested applications (e.g., suggested to the user based on contextual information, such as frequency of use of the respective application, a current location of computer system 600, a day of week, and/or a time of day). First category option 810A corresponds to applications that have at least one unread notification. In some embodiments, as shown in FIG. 8B, first category option 810A includes an indication (e.g., “4”) of the total number of unread notifications of the applications included in the first category option 810A. Second category option 810B corresponds to applications that control attributes of the vehicle. Third category option 810C corresponds to applications that control media playback. Fourth category option 810D corresponds to applications that facilitate communication (e.g., textual communication, such as via instant messaging). In some embodiments, the various category options are dynamic and change over time based on contextual information (e.g., time of day, current location of the computer system, and/or recently performed operations). In some embodiments, first category option 810A is included in the plurality of category options when any application includes at least one unread notification. In some embodiments, first category option 810A is not included in the plurality of category options when there are no unread notifications.

At FIG. 8B, computer system 600 detects an input (e.g., a tap, tap-and-hold, and/or swipe). In accordance with a determination that the input (e.g., 850E) is directed to icon 610O corresponding to a fast navigation application, computer system 600 displays a user interface of the fast navigation application (e.g., by replacing display of user interface 810). In accordance with a determination that the input (e.g., 850F) is directed to first category option 810A, computer system 600 displays unread notifications user interface 830, as shown in FIG. 8C. In accordance with a determination that the input (e.g., 850G) is directed to third category option 810C, computer system 600 displays media user interface 834, as shown in FIG. 8E. Thus, activation of a respective application icon causes display of a user interface of the respective application and activation of a respective category option causes display of a user interface for the respective category.

At FIG. 8C, in response to detecting input 850F directed to first category option 810A, computer system 600 displays unread notifications user interface 830. Unread notifications user interface 830 includes a plurality of objects (e.g., 830A-830C) (e.g., visual elements and/or icons), with each object corresponding to a different application that has one or more unread notifications. Activation of a respective object (e.g., 830A-830C) causes the user interface of the respective application to be displayed (e.g., and optionally automatically show at least one of the unread notifications of the respective application). In some embodiments, unread notifications user interface 830 includes objects that correspond to all or less than all applications that have unread notifications. In some embodiments, computer system 600 determines applications that have unread notifications, groups together the applications with unread notifications, and/or presents respective icons of the applications with unread notifications via unread notifications user interface 830. As a result, computer system 600 provides quick and easy access to applications with unread notifications that the user may want to read. In some embodiments, each object (e.g., 830A-830C) includes an indication of the number of unread notifications for the respective application. For example, messaging object 830B indicates that the messaging application has one unread notification. In some embodiments, unread notifications user interface 830 is dynamic, automatically updating to add icons of applications that transition to having an unread notification (e.g., because an incoming notification is received for the corresponding application and the notification has not been read by the user) and/or automatically updating to remove icons of applications that transition to not having an unread notification (e.g., because the user read the notification). Thus, unread notifications user interface 830 stays updated and provides the user with a user interface where applications with unread notifications can be accessed (e.g., all applications with unread notifications). In some embodiments, unread notifications user interface 830 does not include icons for applications that do not have at least one unread notification.

At FIG. 8C, computer system 600 detects an input (e.g., a tap, tap-and-hold, and/or swipe). In accordance with a determination that the input (e.g., 850H) is directed to messaging object 830B, computer system 600 displays messaging user interface 832, as shown in FIG. 8D. In accordance with a determination that the input (e.g., 850I) is directed to close object 830D, computer system 600 returns to displaying user interface 810 (as in FIG. 8B) or user interface 610 (as in FIG. 8A).

At FIG. 8D, in response to detecting input 850H (at FIG. 8C) or input 850B (at FIG. 8A), computer system 600 displays messaging user interface 832. Messaging user interface 832 includes a plurality of message conversations 832A-832E, including message conversation 832A that has an unread message, as indicated by unread notification 833. In some embodiments, input 850B (at FIG. 8A) results in displaying messaging user interface 832 while input 850H (at FIG. 8B) results in displaying the conversation (with “Lauren A.”) corresponding to message conversation 832A. In some embodiments, activation (e.g., a tap input or tap-and-hold) of message conversation 832A causes computer system 600 to display the conversation (with “Lauren A.”) corresponding to message conversation 832A (including the message that is indicated by the unread notification).

At FIG. 8E, in response to detecting input 850G (at FIG. 8B), computer system 600 displays media user interface 834. Media user interface 834 includes a plurality of media icons 834A-834E. The plurality of media icons 834A-834E are included in media user interface 834 based on their respective applications being media applications. In some embodiments, computer system 600 groups together all media applications and presents their respective icons via media user interface 834. In some embodiments, computer system 600 determines applications that are media applications, groups together the applications that are media applications, and/or presents respective icons of the applications that are media applications via media user interface 834. As a result, computer system 600 provides quick and easy access to media applications that the user may want to use to play back media. In some embodiments, media user interface 834 is scrollable and includes icons for some (not all) or all media applications of the computer system. In some embodiments, activation (e.g., a tap input or tap-and-hold) (e.g., tap input 850J) of icon 834A corresponding to a podcasts application causes computer system 600 to display user interface 836 of the podcasts application, as shown in FIG. 8F. At FIG. 8E, input 850K directed to close object 830F causes computer system 600 to return to displaying user interface 810 (as in FIG. 8B) or user interface 610 (as in FIG. 8A).

At FIG. 8G, in response to detecting input 850A directed to phone icon 610A (at FIG. 8A), computer system 600 displays user interface 838 of the audio communication (e.g., phone) application. FIG. 8H illustrates computer system 600 displaying (e.g., in response to detecting input 850C (e.g., a swipe input directed at user interface 610 at FIG. 8A)) a second page of user interface 610 that includes additional icons 840. Activation of a respective icon of additional icons 840 causes computer system 600 to display a user interface of a respective application that corresponds to the activated respective icon. Accordingly, a user can navigate among different pages of user interface 610 to access different icons of different applications available on computer system 600.

FIGS. 9A-9B is a flow diagram illustrating methods of displaying categories of applications in accordance with some embodiments. Method 900 is performed at a computer system (e.g., 100, 300, 500, and/or 600) (e.g., a smartphone, a wearable (e.g., head-mounted) device, and/or of a vehicle (e.g., an automobile, a boat, or an airplane)) that is in communication with one or more display generation components (e.g., 602) (e.g., one or more display generation components of the vehicle, one or more displays set within a front console of the vehicle, one or more displays positioned ahead of/in front of a driver's seat of the vehicle, one or more heads-up displays, one or more display drivers, and/or one or more displays of a wearable device) and one or more input devices (a touch-sensitive surface, an input device (e.g., a joystick, a scroll wheel, a button, and/or a touch-sensitive surface) (e.g., integrated into a steering wheel of the vehicle), one or more cameras (e.g., for detecting gestures performed in the air), and/or a microphone). In some embodiments, the computer system is in communication with a vehicle (e.g., an automobile, a boat, or an airplane) (e.g., is integrated into the vehicle, is in wired communication with the vehicle, and/or is in wireless communication with the vehicle). Some operations in method 900 are, optionally, combined, the orders of some operations are, optionally, changed, and some operations are, optionally, omitted.

As described below, method 900 provides an intuitive way for displaying categories of applications in accordance with some embodiments. The method reduces the cognitive burden on a user for access different applications, thereby creating a more efficient human-machine interface. For battery-operated computing devices, enabling a user to access applications faster and more efficiently conserves power and increases the time between battery charges.

The computer system (e.g., 600) displays (902) (e.g., in response to a user input detected at the computer system, such as a tap input or an input detected at a knob/joystick), via the one or more display generation components (e.g., 602) (e.g., as part of a center console and/or media console (e.g., of the vehicle)), a first user interface (e.g., 610 at FIG. 8A) (e.g., a home user interface that includes a plurality of application icons and/or folders) that includes a plurality of icons (e.g., 610A-610H) (e.g., that are in an arrangement). The plurality of icons includes: a first icon (904) (e.g., 610A) of a first application (e.g., a full application and/or a lightweight application), wherein activation of (e.g., a tap input on and/or a selection of) the first icon (e.g., 610A) causes display, via the one or more display generation components (e.g., 602), of a user interface (e.g., 838 at FIG. 8G) of the first application and a second icon (906) (e.g., 610D) of a second application (e.g., a full application and/or a lightweight application) that is different from the first application, wherein activation of (e.g., a tap input on and/or a selection of) the second icon (e.g., 610D) causes display, via the one or more display generation components, of a user interface of the second application (e.g., 832 at FIG. 8D).

While displaying the first user interface (e.g., 610) that includes the plurality of icons (e.g., 610A-610H), the computer system (e.g., 600) detects (908), via the one or more input devices, a first input (e.g., 850D) (e.g., a tap input, a series of touch gesture, and/or a series of knob inputs).

In response to detecting the first input (e.g., 850D) and in accordance with a determination that the first input (e.g., 850D) corresponds to a first request (e.g., activates a first user interface object (e.g., 814)), the computer system (e.g., 600) displays (910) (e.g., by replacing the first user interface or concurrently with the first user interface), via the one or more display generation components (e.g., 602), a second user interface (e.g., 810) that includes a plurality of application category options (e.g., 810A-810D), wherein the plurality of application category options (e.g., 810A-810D) includes: a first category option (912) (e.g., 810A) that corresponds to a first set of (e.g., one or a plurality of) applications with a first shared characteristic that includes having an unread notification (e.g., each application has at least one corresponding notification that has not been read or has been marked as unread) and a second category option (914) (e.g., 810C-810D) that corresponds to a second set of (e.g., one or a plurality of) applications with a second shared characteristic that is different from the first shared characteristic, wherein the second set of applications is different from the first set of applications.

While displaying the second user interface (e.g., 810) that includes the plurality of application category options (e.g., 810A-810D), the computer system (e.g., 600) detects (916), via the one or more input devices, a second input (e.g., 850F-850G) (e.g., a tap input, a series of touch gesture, and/or a series of knob inputs).

In response (918) to detecting the second input and in accordance with a determination that the second input (e.g., 850F) activates the first category option (e.g., 810A), the computer system (e.g., 600) displays (920), via the one or more display generation components (e.g., 602), application icons (e.g., 830A-830C at FIG. 8C) of the first set of (e.g., one or a plurality of) applications with the first shared characteristic that includes having an unread notification.

In response (918) to detecting the second input and in accordance with a determination that the second input (e.g., 850G) activates the second category option (e.g., 810C), the computer system (e.g., 600) displays (922), via the one or more display generation components (e.g., 602), application icons (e.g., 834A-834E at FIG. 8E) of the second set of (e.g., one or a plurality of) applications with the second shared characteristic. Displaying application icons of different sets of applications provides the user with visual feedback about the applications that are accessible from respective category options. In addition, displaying categorized accessories enables users to quickly access an application of interest, such as applications that have corresponding unread notifications, thereby providing an improved man-machine interface.

In some embodiments, the plurality of application category options (e.g., 810A-810D and contents at FIGS. 8C and 8E) does not include an icon corresponding to the first application (e.g., for the phone application with icon 610A). In some embodiments, an icon (e.g., the first icon) of the first application is not included in any of the category options of the second user interface. In some embodiments, the computer system displays (e.g., as part of the first user interface and/or different pages of a home screen user interface) an icon for displaying a respective application, but the respective application is not included in any of the application category options displayed as part of the second user interface. In some embodiments, the plurality of application category options include icons that correspond to less than all of the applications available for display (e.g., via the first user interface) at the computer system. Not including all applications in the plurality of application category options enables the computer system to provide the user with access to more relevant applications (e.g., without displaying icons for applications that are unlikely to be used), thereby providing an improved man-machine interface.

In some embodiments, the first user interface (e.g., 610) (e.g., a home user interface that includes a plurality of application icons and/or folders) includes a first user interface object (e.g., 814) (e.g., a search option and/or category button) and the determination that the first input (e.g., 850D) corresponds to the first request includes a determination that the first input (e.g., 850D) activates the first user interface object (e.g., 814). Displaying the first user interface object indicates to the user that an option to access the plurality of application category options is available, thereby providing improved feedback. Additionally, displaying the plurality of application category options in response to detecting activation of the first user interface object provides the user with feedback that the first input was received, thereby providing improved visual feedback.

In some embodiments, in response to detecting the second input (e.g., 850D) and in accordance with the determination that the second input activates the first category option (e.g., 810A), forgoing displaying a user interface of an application. In some embodiments, in response to detecting the second input and in accordance with the determination that the second input activates the second category option, forgoing displaying a user interface of an application. In some embodiments, activation of a respective category option displays icons of applications that are in the respective category without displaying a user interface of an application that is in the respective category. Forgoing displaying a user interface of an application based on selection of a respective category option enables the computer system to instead display multiple icons for multiple applications, thereby enabling the user to select a relevant application and improving the man-machine interface.

In some embodiments, in response to detecting the first input (e.g., 850D) and in accordance with the determination that the first input corresponds to the first request (e.g., activates a first user interface object), the computer system (e.g., 600) displays (e.g., as part of the second user interface), via the one or more display generation components (e.g., 602) and concurrently with the plurality of application category options (e.g., 810A-810D), one or more (e.g., one, two, three, or five) icons (e.g., 610N-610P, 610G, and 810B) of suggested applications, wherein activation of (e.g., a tap input on and/or a selection of) a respective icon (e.g., 610O) of the one or more icons of suggested applications causes display, via the one or more display generation components (e.g., 602), of a user interface of a respective suggested application. In some embodiments, the computer system selects the suggested applications based on contextual information, such as based on one or more of (e.g., some or all of): frequency of usage of applications, recency of user of applications, a current location of the computer system, and/or a relevancy of the application. Concurrently displaying the one or more icons of suggested applications (e.g., based on contextual information) enables the computer system to provide the user with suggested applications that may be relevant to the user and that can be activated without needing to first activate an application category option, thereby reducing the number of inputs required.

In some embodiments, the respective suggested application (e.g., corresponding to icon 610O) is included in the first set of (e.g., one or a plurality of) applications with the first shared characteristic (e.g., as part of the first category option) (e.g., if the fast nav application was included in 810A). In some embodiments, the respective suggested application is included in the second set of (e.g., one or a plurality of) applications with the second shared characteristic (e.g., as part of the second category option). Displaying an application as both a suggested application and as part of an application category option enables the computer system to both provide the user with a suggested application that may be relevant to the user and also allow the user to see that same application as part of a relevant category (e.g., so that the user can then pick from among applications of that category), thereby improving the man-machine interface.

In some embodiments, the respective suggested application (e.g., corresponding to icon 610O) is not included in the plurality of application category options (e.g., 810A-810D) (e.g., is not included in the first set of applications and is not included in the second set of applications). Not displaying a respective suggested application as part of the application category options (even when the respective suggested application has the appropriate characteristic) enables the computer system to display additional other applications as part of the application category option, thereby providing the user with increased options and improving the man-machine interface.

In some embodiments, the plurality of application category options (e.g., 810A-810D) does not include an icon (e.g., 610C) of a currently installation application on the computer system. In some embodiments, the plurality of application category options includes icons for many, but not all, applications that are installed on the computer system. The application category options not including every single application that is installed on the computer systems allows the computer system to provide the user with the most relevant category options without the need to take up space displaying an option for each and every application, thereby improving the man-machine interface.

In some embodiments, the first set of applications includes a respective application (e.g., the first application, which has the first shared characteristic) and the second set of applications includes the respective application (e.g., the first application, which has the second shared characteristic). In some embodiments, the same application is included in multiple application category options of the plurality of application category options. Including a respective application in multiple category options enables the computer system to provide the user with access to the respective application at all of the multiple categories (e.g., when the respective application has the shared characteristic (e.g., unread notification) for the first category option and the shared characteristic (e.g., mapping application) for the second category option), thereby providing the user with improved visual feedback.

In some embodiments, respective applications are included in only a single application category option of the plurality of application category options (e.g., 810A-810D). In some embodiments, the same application is not included in multiple application category options. In some embodiments, the first set of applications and the second set of applications are mutually exclusive (do not have any of the same applications). Not including the same respective application in multiple category options enables the computer system to use the display space to display icons for other applications, thereby providing improved visual feedback.

In some embodiments, in response to detecting the first input (e.g., 850C) and in accordance with a determination that the first input corresponds to a page change request (e.g., a swipe input, a touch gesture, and/or a series of knob inputs), the computer system (e.g., 600) updates display, via the one or more display generation components (e.g., 602) (e.g., as part of a center console and/or media console (e.g., of the vehicle)), of the first user interface (e.g., 610 at FIG. 8A to 610 at FIG. 8H) (e.g., a home user interface that includes a plurality of application icons and/or folders) to replace the plurality of icons (e.g., 610A-610H) with a second plurality of icons (e.g., 840) (e.g., that are in the same arrangement), wherein the second plurality of icons includes: a third icon of a third application (e.g., a full application, a lightweight application, and/or different from the first and second application), wherein activation of (e.g., a tap input on and/or a selection of) the third icon causes display, via the one or more display generation components, of a user interface of the third application; and a fourth icon of a fourth application (e.g., a full application, a lightweight application, and/or different from the first and second application) that is different from the third application, wherein activation of (e.g., a tap input on and/or a selection of) the fourth icon causes display, via the one or more display generation components, of a user interface of the fourth application. In some embodiments, the first user interface includes a plurality of pages, and the computer system switches among pages based on user input (e.g., a swipe input). Enabling the user to navigate to a different page of the home screen allows the user to view additional applications icons that are in pre-defined (e.g., user-specified) locations and that can be activated, thereby providing the user with additional options for displaying user interfaces of applications and improving the man-machine interface.

In some embodiments, in response to detecting the first input (e.g., 850A and/or 850B): in accordance with a determination that the first input (e.g., 850A) corresponds to activation of (e.g., tap input on and/or selection via a knob/joystick) the first icon (e.g., 610A) of the first application, the computer system (e.g., 600) displays (e.g., by replacing the first user interface or concurrently with the first user interface), via the one or more display generation components (e.g., 602), the user interface (e.g., 838 at FIG. 8G) of the first application and in accordance with a determination that the first input (e.g., 850B) corresponds to activation of (e.g., tap input on and/or selection via a knob/joystick) the second icon (e.g., 610D) of the second application, the computer system (e.g., 600) displays (e.g., by replacing the first user interface or concurrently with the first user interface), via the one or more display generation components (e.g., 602), the user interface (e.g., 832 at FIG. 8D) of the second application. Displaying a user interface of an application based on the respective icon of the application being activated provides the user with visual feedback that the input was received and allows the user to access the user interface of the application, thereby providing improved visual feedback.

Note that details of the processes described above with respect to method 900 (e.g., FIGS. 9A-9B) are also applicable in an analogous manner to the methods described above. For example, method 900 optionally includes one or more of the characteristics of the various methods described above with reference to method 700. For example, the first user interface described with respect to method 700 is the same as the first user interface described with respect to method 900. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve user interfaces. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver user interfaces that are of greater interest to the user. Accordingly, use of such personal information data enables users to have calculated control of the user interfaces. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case user-specific user interfaces, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may 1613379205 be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user interfaces can be selected and displayed by inferring preferences based on non-personal information data or a bare minimum amount of personal information.

What is claimed is:

1. A computer system configured to communicate with one or more display generation components, comprising:
one or more processors; and
memory storing one or more programs configured to be executed by the one or more processors, the one or more programs including instructions for:
displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including:
a first icon of a first lightweight application that corresponds to a first operation of the first full application, wherein activation of the first icon causes display, via the one or more display generation components, of a user interface of the first lightweight application corresponding to the first operation of the first full application; and
a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application;
after displaying the first user interface that includes the folder, receiving a request to download and/or install an application; and
in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

2. The computer system of claim 1, the one or more programs further including instructions for:
in response to receiving the request to download and/or install the application and in accordance with a determination that the application is a second full application, different from the first full application, automatically updating the first user interface to include an icon of the second full application without replacing the folder with the icon of the second full application, wherein activation of the icon of the second full application causes display, via the one or more display generation components, of a user interface of the second full application.

3. The computer system of claim 1, the one or more programs further including instructions for:
while displaying the first user interface with the folder, detecting activation of the folder that contains the first plurality of icons corresponding to the respective plurality of lightweight applications; and
in response to detecting activation of the folder, displaying, via the one or more display generation components:
the first icon of the first lightweight application; and
the second icon of the second lightweight application.

4. The computer system of claim 3, the one or more programs further including instructions for:
detecting an activation input; and
in response to detecting the activation input:
in accordance with a determination that the activation input is directed to the first icon of the first lightweight application, displaying, via the one or more display generation components, a user interface of the first lightweight application, wherein the user interface of the first lightweight application includes an option to perform the first operation; and
in accordance with a determination that the activation input is directed to the second icon of the second lightweight application, displaying, via the one or more display generation components, a user interface of the second lightweight application, wherein the user interface of the second lightweight application includes an option to perform a second operation that is different from the first operation.

5. The computer system of claim 1, the one or more programs further including instructions for:
detecting activation of the icon of the first full application; and
in response to detecting activation of the icon of the first full application, displaying, via the one or more display generation components, a user interface of the first full application.

6. The computer system of claim 5, wherein the first full application is configured to provide the first operation of the first lightweight application and the second operation of the second lightweight application.

7. The computer system of claim 5, wherein the first full application is configured to provide all of the operations of the first lightweight application and all of the operations of the second lightweight application.

8. The computer system of claim 5, wherein the first full application is configured to provide more operations than provided by the respective plurality of lightweight applications.

9. The computer system of claim 5, the one or more programs further including instructions for:
receiving a first set of one or more user inputs; and
in response to receiving the first set of one or more user inputs, navigating the first full application to access a user interface of the first full application that is configured to initiate the first operation.

10. The computer system of claim 9, the one or more programs further including instructions for:
receiving a second set of one or more user inputs; and
in response to receiving the second set of one or more user inputs, navigating the first full application to access a user interface of the first full application that is configured to initiate the second operation.

11. The computer system of claim 1, wherein displaying the first user interface that includes the folder includes displaying the folder at a first position within an arrangement of user interface objects that includes a plurality of application icons.

12. The computer system of claim 11, wherein automatically updating the first user interface to replace the folder with the icon of the first full application includes displaying the icon of the first full application at the first position within the arrangement of the user interface objects that includes the plurality of application icons.

13. The computer system of claim 11, wherein the arrangement of the user interface objects includes an arrangement that is spread across a plurality of pages.

14. The computer system of claim 1, wherein automatically updating the first user interface to replace the folder with the icon of the first full application includes ceasing to display the folder.

15. The computer system of claim 1, wherein automatically updating the first user interface to replace the folder with the icon of the first full application includes deleting the first icon of the first lightweight application and the second icon of the second lightweight application.

16. The computer system of claim 1, the one or more programs further including instructions for:
in response to receiving the request to download and/or install the application and in accordance with the determination that the application is the first full application, deleting the first lightweight application and the second lightweight application.

17. The computer system of claim 1, the one or more programs further including instructions for:
in response to receiving the request to download and/or install the application and in accordance with the determination that the application is the first full application:
in accordance with a determination that a third icon of a third lightweight application that corresponds to the first full application is in the folder, deleting the third icon of the third lightweight application; and
in accordance with a determination that the third icon of the third lightweight application that corresponds to the first full application is not in the folder, forgoing deleting the third icon of the third lightweight application.

18. The computer system of claim 1, wherein the first lightweight application and the second lightweight application correspond to a manufacturer of a vehicle in which the computer system is installed.

19. A non-transitory computer-readable storage medium storing one or more programs configured to be executed by one or more processors of a computer system that is in communication with one or more display generation components, the one or more programs including instructions for:
displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including:
a first icon of a first lightweight application that corresponds to a first operation of the first full application, wherein activation of the first icon causes display, via the one or more display generation components, of a user interface of the first lightweight application corresponding to the first operation of the first full application; and
a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application;
after displaying the first user interface that includes the folder, receiving a request to download and/or install an application; and
in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.

20. A method, comprising:
at a computer system, wherein the computer system is in communication with one or more display generation components:
displaying, via the one or more display generation components, a first user interface that includes a folder, wherein the folder contains a first plurality of icons corresponding to a respective plurality of lightweight applications, each icon of the first plurality of icons representing an operation of a first full application, the first plurality of icons including:
a first icon of a first lightweight application that corresponds to a first operation of the first full application, wherein activation of the first icon causes display, via the one or more display generation components, of a user interface of the first lightweight application corresponding to the first operation of the first full application; and
a second icon of a second lightweight application that corresponds to a second operation of the first full application, wherein the second lightweight application is different from the first lightweight application and activation of the second icon causes display, via the one or more display generation components, of a user interface of the second lightweight application corresponding to the second operation of the first full application;
after displaying the first user interface that includes the folder, receiving a request to download and/or install an application; and
in response to receiving the request to download and/or install the application and in accordance with a determination that the application is the first full application, automatically updating the first user interface to replace the folder with an icon of the first full application, wherein activation of the icon of the first full application causes display, via the one or more display generation components, of a user interface of the first full application.
